(19) United States
(12) Patent Application Publication
(10) Pub. No.: US 2019/0205905 A1
(43) Pub. Date: Jul. 4, 2019

(54) Machine Learning-Based Systems and Methods of Determining User Intent Propensity from Binned Time Series Data

(71) Applicant: OneMarket Network LLC, San Francisco, CA (US)

(72) Inventors: Ramya Raghunathan, San Francisco, CA (US); Raghav Lal, Palo Alto, CA (US)

(73) Assignee: OneMarket Network LLC, San Francisco, CA (US)

(21) Appl. No.: 16/189,993

(22) Filed: Nov. 13, 2018

Related U.S. Application Data
(60) Provisional application No. 62/612,570, filed on Dec. 31, 2017.

(51) Int. Cl. G06Q 30/02; G06K 9/62; G06N 3/04; G06Q 30/06

(52) U.S. Cl. CPC G06Q 30/0202; G06K 9/6223; G06K 9/6267; G06Q 30/0633; G06N 3/04; G06Q 30/0201; G06K 9/6256

(57) ABSTRACT

Mobile devices with multiple radios (even if software defined) create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

### CROSS-REFERENCE TO OTHER APPLICATIONS

Applicant hereby claims the benefit under 35 U.S.C. 119(e) of U.S. provisional application No. 62/612,570, filed 31 Dec. 2017, entitled “MACHINE LEARNING-BASED SYSTEMS AND METHODS OF DETERMINING USER INTENT PROPENSITY FROM BINNED TIME SERIES DATA” (Attorney Docket No. PYME 1003-1). The provisional application is hereby incorporated by reference.

The provisional application above is one of six related provisional applications filed the same day, Dec. 31, 2017. The applications are: U.S. Application No. 62/612,568, entitled “SYMBIOTIC REPORTING CODE AND LOCATION TRACKING INFRASTRUCTURE FOR PHYSICAL VENUES” (Attorney docket PYME 1002-1); U.S. Application No. 62/612,570, entitled “MACHINE LEARNING-BASED SYSTEMS AND METHODS OF DETERMINING USER INTENT PROPENSITY FROM BINNED TIME SERIES DATA” (Attorney docket PYME 1003-1); U.S. Application No. 62/612,571, entitled “USING MACHINE LEARNED VISITOR INTENT PROPENSITY TO GREET AND GUIDE A VISITOR AT A PHYSICAL VENUE” (Attorney docket PYME 1004-1); U.S. Application No. 62/612,573, entitled “PROVIDING GENDER AND AGE CONTEXT FOR USER INTENT WHEN BROWSING OR SEARCHING (Attorney docket PYME 1005-1); U.S. Application No. 62/612,576, entitled “GENERATING AN INDIVIDUALIZED ENSEMBLE OF COMPLEMENTARY ITEMS IN COMPLEMENTARY ITEM CATEGORIES” (Attorney docket PYME 1006-1); and U.S. Application No. 62/612,578, entitled “SYSTEMS AND METHODS OF INDIVIDUALIZED INCENTIVES TO MODIFY SHOPPER BEHAVIOR” (Attorney docket PYME 1007-1). These applications are hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Visitors to venues can download a venue specific application and get a map or narrative of what they are viewing. They can scan a code to bring up a web page, if they have the right software. But the present tools are clumsy and do not make a physical visit engaging in the same ways that online visits are engaging.

Mobile devices have been engineered to reduce their trackability and give users explicit control over sharing of data from location services. This can make it clumsier for a user to set up their mobile device to assist them during a journey. It also makes it more difficult for a venue operator to interact with a user, virtually propelling the venue operator to build their own app to run on a wide variety of mobile devices.

Recommendation engines in mobile apps are primitive, compared to their online counterparts. Data sources from which to generate recommendations are generally not available to physical location operators in the same way that they are available to search engines that touch so many aspects of an online visitor's life at and outside work.

Discerning user intent has grown very refined for search engines. For instance, hundreds of patents have issued in international class G06F covering nuances of discerning user intent. Visitors to a physical venue have not yet experienced the benefits of efforts to discern their intent and assist them in their journey. The tools of big data have yet to be practically application to the journey of visitors through physical venues such as museums, galleries, historical structures, and malls.

An opportunity arises to leverage mobile device tracking capabilities, big data, intent discovery and recommendation engines to improve visitors experience, both when visiting a physical venue and when exploring online venues, including virtual realities. Improved visitor experience and engagement, higher satisfaction and retention, and conversion of interests may result.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a block diagram that shows various aspects of the technology disclosed.

FIG. 2 illustrates tracking of a visitor's journey through tenant locations of a physical venue in accordance with one implementation. In other implementations, the tenant locations are store locations of an independent retailer store that is not in a tenant-landlord relationship.

FIG. 3A depicts location-based infrastructure of beacons deployed to the physical venue of FIG. 1, and a server beacon resolver configured to determine visitor location based on receipt of beacon messages by a mobile device carried by the visitor.

FIG. 3B depicts location-based infrastructure of registered visitor Wi-Fi access points deployed to the physical venue of FIG. 1, and a server Wi-Fi resolver configured to determine visitor location based on receipt of MAC address identifiers by the mobile device carried by the visitor.

FIG. 4 shows one implementation of an aggregated profile with a master identifier (ID) created for the visitor.

FIG. 5 lists some examples of retailer-related attributes that are included as binned profile data in the aggregated profile of FIG. 4.

FIG. 6 lists some examples of venue-related attributes that are included as binned profile data in the aggregated profile of FIG. 4.

FIG. 7 shows some examples of shopper propensities that are included in the aggregated profile of FIG. 4.

FIG. 8 illustrates a distribution server that uses the aggregated profile of FIG. 4 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship.

FIGS. 9, 10A and 10B show a conversion engine that uses the aggregated profile of FIG. 4 to identify in-retailer and overall purchase propensities for converting shoppers to in-retailer purchases.

FIG. 11 depicts one implementation of a dashboard that graphically presents various venue intelligence metrics to a venue operator.

FIG. 12 illustrates one implementation of a dashboard that graphically presents various visitor activity metrics to a venue operator.

FIG. 13 is one implementation of a dashboard that graphically depicts various shopper attributes across a plurality of shopper stratums.

FIG. 14 illustrates a message modifier that uses the aggregated profile of FIG. 4 to determine shopper intent and propensities, and in response modify messages and engagement schemes used by the tenants to interact with the shoppers. In other implementations, the tenants are independent retail stores that are not in a tenant-landlord relationship.

FIG. 15 is a message sequence chart of determining an incentive offer for a shopper using the aggregated profile of FIG. 4 and using the incentive offer to cause the shopper to return goods at a physical location instead of returning online.

FIG. 16 shows one example of the incentive offer described in FIG. 15.

FIG. 17 is a message sequence chart of determining an incentive offer for a shopper using the aggregated profile of FIG. 4 and using the incentive offer to cause the shopper to pick up goods at a physical location rather than request shipping.

FIG. 18 shows one example of the incentive offer described in FIG. 17.

FIG. 19 depicts a message sequence chart of enhancing a user browsing experience using an ensemble engine that generates product recommendations based on a shopper's purchase history, intent and propensity data identified in the aggregated profile of FIG. 4.

FIGS. 20A and 20B show one example of how the user browsing experience is enhanced by the ensemble engine of FIG. 19.

FIG. 21A shows one implementation of a training stage in which machine learning-based models are trained on training data to output user intent and propensity information.

FIG. 21B shows one implementation of a production/inference stage in which trained machine learning-based models from FIG. 21A are used to evaluate production data and output user intent and propensity information.

FIG. 22 is a message sequence chart of using the aggregated profile of FIG. 4 to make personalized recommendations to a shopper.

FIG. 23A shows one implementation of a shopper profile accessible to a retail store operator.

FIG. 23B is one implementation of an interface that can be used by a retail store operator to request new or updated shopper profiles.

FIG. 24 is one implementation of a computer system that can be used to implement the technology disclosed.

FIG. 25 shows a block diagram of a purchase propensity predictor that produces user purchase propensity scores.

FIG. 26 shows a simplified diagram of a gradient tree boosting algorithm.

FIG. 27 shows a block diagram for an LSTM algorithm.

FIGS. 28A, 28B, 28C and 28D show four implementations of LSTM-based classifiers used by the propensity predictor.

FIG. 29 shows classification results for the gradient tree boosting implementation of the classifier.

FIG. 30 shows evaluation statistics for the gradient tree boosting implementation of the classifier. FIG. 26 shows a simplified diagram of a gradient tree boosting algorithm

### DETAILED DESCRIPTION

### Introduction

Retail venues, now called “brick and mortar”, face stiff competition from online portals, which are perceived as having lower prices, better selection, and delivery. Portals have the further advantage of ease of use, when well designed, and powered by recommendation engines.

Mobile devices with multiple radios (even if software defined) create an opportunity for retail venues to present new messaging channels to visitors, even visitors who do not subscribe to or do not activate a venue app. Venue operators are uniquely situated to aggregate data before a visit and to track a user during a visit, because their sole objective is to increase overall venue traffic and conversion to sales, without favoritism among tenants.

Structural safeguards and contractual commitments allow a venue operator to aggregate individualized visitor data across tenants of numerous venues and combine tenant data with other retailer data for analysis. Anonymized aggregate data, in the sense that contributions to individual visitor aggregates cannot be reverse engineered, can be stored side-by-side with retailer-specific data, without risk of leakage between retailers. This involves careful architecting of database structures and access routines.

On the data collection side, physical control of venue common space allows the venue operator to combine membership-based free WiFi with symbiotic software loops in active background applications, which report encrypted BLE beacon messages for decryption, to accurately track a visitor's journey through an indoor venue, while respecting user permissions. Cooperation with tenants allows the venue operator to extend hyper-location tracking beyond entry into a tenant's space, beyond the common areas. This involves substantial physical infrastructures. With this overview in mind, additional detail is more easily understood.

Access to point of sale and online sale data, at a SKU/UPC level and across retailers who view themselves as competitors, allows a venue operator to predict aggregate purchasing propensities, as well as retailer specific purchasing patterns. For instance, artificial intelligence systems can be trained with data that ordinarily could not be aggregated. Separate models can be trained with the aggregated and retailer-specific data. Training models on binned data is more efficient and practical than training on of individual purchase events. Binning requires creation and maintenance of a SKU hierarchy that spans diverse product offerings of tenants and other retailers, because there are too many SKUs to train artificial intelligence systems using individual SKUs. Practically, the venue operator's SKU hierarchy should also be a Rosetta stone of sorts, providing two-way translation between the AI's hierarchy of categories and each retailer's own hierarchy of categories. The SKU hierarchy is structured to power an individualized recommendation engine (as opposed to look alike, collaborative filtering.) New applications of big data analytics to prediction of purchase propensities are possible with newly aggregated data, with binning facilitated by a cross-retailer SKU hierarchy. Pre-calculation from historical, binned data can be combined with location tracking indoors, within a venue, during a visitor's journey or “at a moment in time.”.

Symbiotic software loops in a critical mass of active background applications can effectively report and decode encrypted beacons and other signal propagated indoors, within a venue that a visitor's mobile device otherwise would miss if the visitor did not activate the venue's app or subscribe to the venue's free Wi-Fi. Symbiotic software loops are developed using software developer kits (SDKs) adopted by popular applications that are interested in geo location of users. Symbiotic software code is called from the main processing loop of an application when the application is in the foreground or the active background. The active background operation is important, because applications are quickly displaced from the foreground into the background. Mobile device operating systems limit the number of background applications that are active, in order to conserve battery life. If a mobile phone, for instance, has 15 applications loaded in the background, a handful, perhaps four or five of those applications are in the active background. Applications in the active background continue to operate, without painting the display. Presence in the active background makes an application effective at listening for encrypted BLE beacon signals. When two, three or half a dozen social media, ride sharing, navigation and other location-aware applications on an individual mobile device implement symbiotic software loops, it is likely that one of the applications will be in the foreground or active background throughout a visitor's journey at the venue. By accepting active background processing, the portals that sponsors an application gains improved location resolution while the mobile device is indoors; symbiotically, the venue operator gains a new tool for tracking a visitor's journey. For instance, a ride sharing operator can tell which door at which level a visitor is approaching as they exit an airline terminal to catch a ride, even before the sky is visible to the mobile device's GPS. This encourages the application portal to adopt the symbiotic software loop, as one of multiple tracking approaches.

Membership based free Wi-Fi is another tool for location tracking, using access point infrastructure that reports data about connected mobile devices. Before a mobile device connects, its MAC address is likely to be obfuscated. Mobile devices have been engineered to obfuscate MAC addresses, prior to actual network connection, in order to defeat unauthorized location tracking. For instance, one manufacturer of popular cell phones rotates the obfuscated MAC address approximately every six hours. Its mobile devices use an obfuscated MAC address prior to actual connection to an access point. Membership based free Wi-Fi access provides an identifier, such as email address, that the links a connected MAC address to aggregated data for the mobile device. Upon connection, the MAC address becomes a unique identifier for following a visitor's journey, reported by access point infrastructure as the visitor moves through the venue. Without a connection, infrastructure can merely track the obfuscated MAC address, without being given a meaningful identifier of the mobile device.

Tracking and unveiling obfuscated MAC addresses is an opportunity afforded by venue infrastructure with multiple radio infrastructures. Prior to a Wi-Fi connection, symbiotic software loops can follow mobile device through the venue. Upon connection, a server can correlate location data from symbiotic software loops with tracking location data from the obfuscated MAC address. In some instances, the simple correlation between beacon location resolution and obfuscated MAC address location resolution can be provide a reliable correlation. In other instances, connection of the Wi-Fi in to an access point will strengthen the correlation enough to match obfuscated journey location information with beacon derived location data. Operation and coordination of the two infrastructures creates an opportunity for linking tracks independently generated from the mobile device.

Location data can be combined with periodically calculated propensity data to enhance a visit to a venue. The visitor's likely intent for a visit can be predicted upon arrival by accessing data that has been analyzed for patterns and propensities. When a visitor arrives at a venue, they can be identified and propensities retrieved, which have been pre-calculated on a periodical basis applying big data techniques to aggregated, binned, category-level SKU data. Profile and propensity data, including destination specific and aggregated propensity data can be fed to retailers at the venue.

The venue operator can solicit greeting messages for an identified visitor upon arrival. Greeting messages can featured products and include incentives, or provide friendly greetings. The venue operator can improve the user experience by prioritizing and/or grouping messages. The number and content of messages delivered can be determined by the venue operator to improve visitor experience, to avoid bombardment of the visitor with excessive, noisy messaging. This greeting protocol sometimes is enhanced by a strong indication of the visitor's intent.

Aggregation of data will sometimes allow a strong prediction of a visitor's primary and secondary intent immediately upon arrival, based either on recent behaviors or periodic patterns. For instance, a visitor who browsed online for repair services in the last hour may be headed to a repair shop at the venue; they may have an expected waiting time for completion of the repair. Recent browsing activity may suggest where to direct the user during their waiting time and what kind of messaging will enhance the visitor's journey. Periodic behavior, such as picking up coffee midmorning or eating lunch at the venue, also can be ascertain from the profile and the aggregated data, which can be combined when soliciting candidate messages.

Profiles created using aggregated and retailer-specific data also can be used to precipitate a visit, thereby increasing foot traffic in the venue. Two opportunities to bring an online user to a store are order fulfillment order and return of goods purchased online.

When a user buys from a retailer who has a physical presence at a location that the user visits, the online user may be converted to a visitor by offering to make the goods available immediately at a pick-up counter at a venue. This may require little effort for frequent visitors, as indicated by their retailer-specific profiles. Pick-up today caters to some of the same instincts that cause coffee buyers to pre-order and prepay their morning java dose, for pickup without waiting in line. A user who seldom visits the retailer's physical location may require an extra nudge.

Customized incentives to pick up goods by visiting a physical location can be crafted based on goods specific information and a user profile. While free shipping is enticing to buyers, it is not free to sellers. Part of a custom incentive can be funded by reduced shipping costs. Many shoppers buy a few more things when they happen to visit a venue, so an incentive can be fashioned for discounted purchases today, for instance, that increase the likelihood that a visit to pick up goods will convoy additional purchases.

Elasticity, as a factor in customization of pickup incentives, can be assessed using data aggregated across retailers, which will reveal users with a propensity to take advantage of pick-up today options. It also may reveal proven pick-up visitors who are not aware of a pick-up location that would be convenient for them to visit.

Return of goods purchased online is a further opportunity to precipitate a visit that increases foot traffic in the venue. Returns can be more expensive for an online retailer to process than fulfillments, when the return address is different than the fulfillment address. This is the case when fulfillment is directly from a manufacturer's warehouse, instead of a retailer's distribution center. A customized incentive can be offered to return or exchange goods in-store, potentially avoiding two way shipping costs. As with pick up of goods, part of a custom incentive can be funded by reduced shipping costs. Another part of an incentive can be based on a likelihood that a visit to pick up goods will convoy additional purchases. Elasticity can be assessed to gauge an amount of incentive that is likely to succeed in precipitating a visit.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

Overall, a combination of precise location tracking, without requiring visitor activation during a journey, and big data analysis of data aggregated across retailers/venues/platforms has many opportunities for brick and mortar retailers to recapture market share from online platforms by providing new services that have no online analog and by reproducing and adapting the best of online experiences for location based experiences.

During a visit, whether detected or precipitated, ensembles can be offered on an individualized basis. In general, recommendation engines typically are based on look-alikes, what other customers bought along with the current SKU/product. Current recommendation engines do not check size availability or take into account a particular online visitor's brand, color or style preferences. With a SKU category hierarchy, individualized visitor histories and binned profiles can be used to fashion product ensembles that are individualized. From look-alike data, ensembles of SKU/product categories can be assembled. Individual SKUs/products can be selected to fill the categories from individualized data. Product availability can be taken into account when an individualized ensemble is constructed. This approach can be applied both in store and online. In a store, a user who is browsing the retailer's app or the venue operator's app can receive from a server personalized ensemble recommendations. Or a personal shopping assistant or concierge can receive the recommendations and convey them to the shopper. Online, the user can receive the personalized recommendations as browsing and buying proceed.

During online visits, gender context intent can be determined from aggregate history data, including both online and physical history, based on Bayesian likelihood of within SKU/product categories, brand or retailer or based on recent browsing. Many households have a Chief Shopping Officer. In households of four people, some CSOs will shop for male and female adults and male and female dependents, plus friends and relatives. When they visit online looking for pants, are they looking on behalf of a male or female and on behalf of an adult or child? Binned profile data within a SKU/product category hierarchy can yield a Bayesian likelihood of gender context and/or age context. The Bayesian estimate is stronger when more factors are taken into account. Often, different retailers are visited to satisfy different gender contexts and or age contexts. Brands also can differentiate between gender and age contexts. Once gender and approximate age contexts are established, specific propensities and preferences, as discussed above regarding ensembles, can be brought to bear so the first array of products displayed have a substantial likelihood of matching the visitor's intent.

Aggregated data can be utilized increase sales in underrepresented categories, both during physical and online visits and by direct marketing. Retailers tend to underestimate buying propensity for a sizable portion of their customers, when they make estimates based on retailer-specific purchases. In one sample, 18 percent of users had a higher overall purchase propensity for makeup than would be estimated from their retailer-specific history. At the point of sale, during a visit, a sales person can be given an overall propensity for SKUs/products in a department, for an ensemble, or across the store. Categories in which the overall propensity exceeds the retailer-specific propensity can be highlighted to a sales person to motivate efforts to convert the visitor to fulfill their intent in-store, instead of elsewhere. Incentives can be provided to help convert the visitor. Online, featured products can be selected based on the overall propensity and can be directed to conversion of intent to goods available from the online retailer's own site. Direct marketing also can take advantage of identified opportunities with messages and incentives designed to capture a larger share of a current customer's spend in a category that is more often fulfilled elsewhere.

Considering again physical visits, extra attention can be directed to visitors who have a history of buying luxury goods. Retailers that have active customer service tend to sell at least some high priced or luxury goods. Selling high priced goods with a substantial margin pays for customer service and even for personal shopping service. Customer profiles can be used to identify luxury shoppers and big spenders when they start their journey through a venue. Journey tracking technologies described above can follow the visitor as they approach a particular retailer. Customer service, personal shopping or concierge staff can be alerted to the arrival of high value visitor. A picture can be provided from a profile, if available. A real time approach track, as available with ride sharing services, also could be provided from the BLE and/or Wi-Fi tracking infrastructures described above.

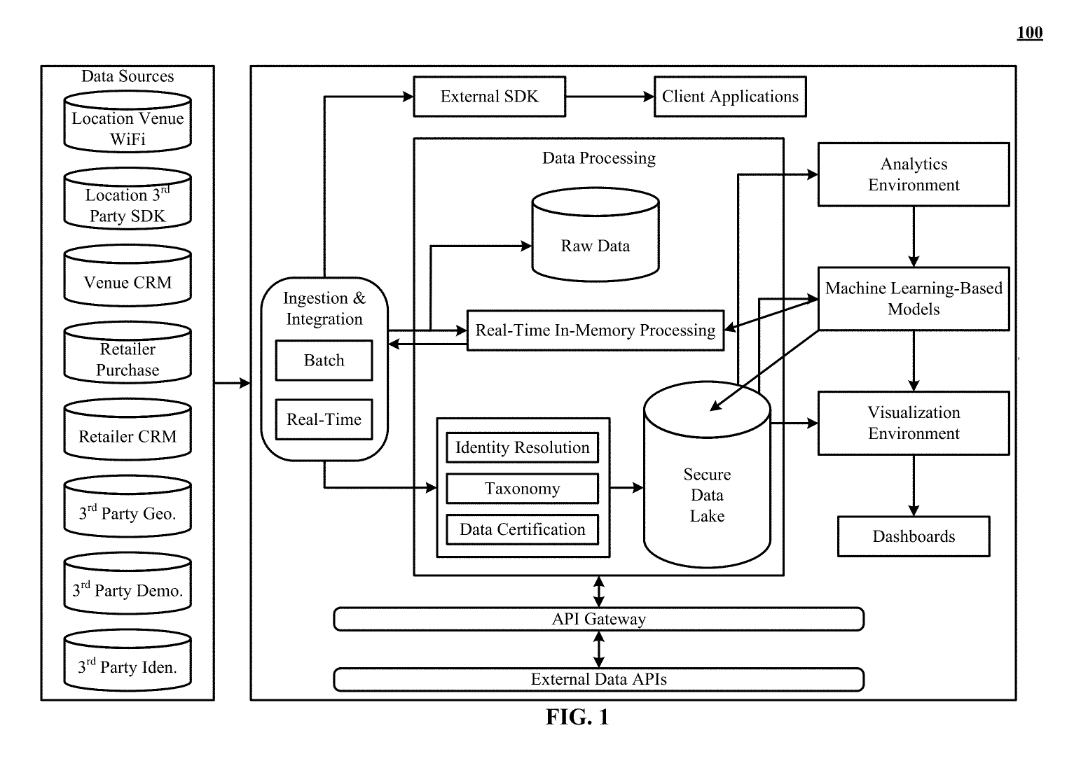

FIG. 1 is a block diagram that shows various aspects of the technology disclosed. FIG. 1 includes system 100. System 100 includes a plurality of data sources, such as WiFi-based location data from venue WiFi access points, beacon-based location data from 3^{rd} party SDKs, venue customer relationship management (CRM) data, retailer purchase data, retailer CRM data, 3^{rd} party geolocation data, 3rd party demographics data and 3^{rd} party identity data.

System 100 also includes an ingestion and integration sub-system, which can provide batch processing (e.g., Hadoop or Storm) as well as stream or real-time processing (e.g., Spark). Both processing styles can use a messaging queue such as Kafka as a source and/or sink.

Data from the data sources and via the ingestion and integration engine is provided to a data processing sub-system. Data processing sub-system includes a real-time in-memory processing component which can use machine learning-based models to predict insights in real time. Examples of predictive insights include user intent and user propensities. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models.

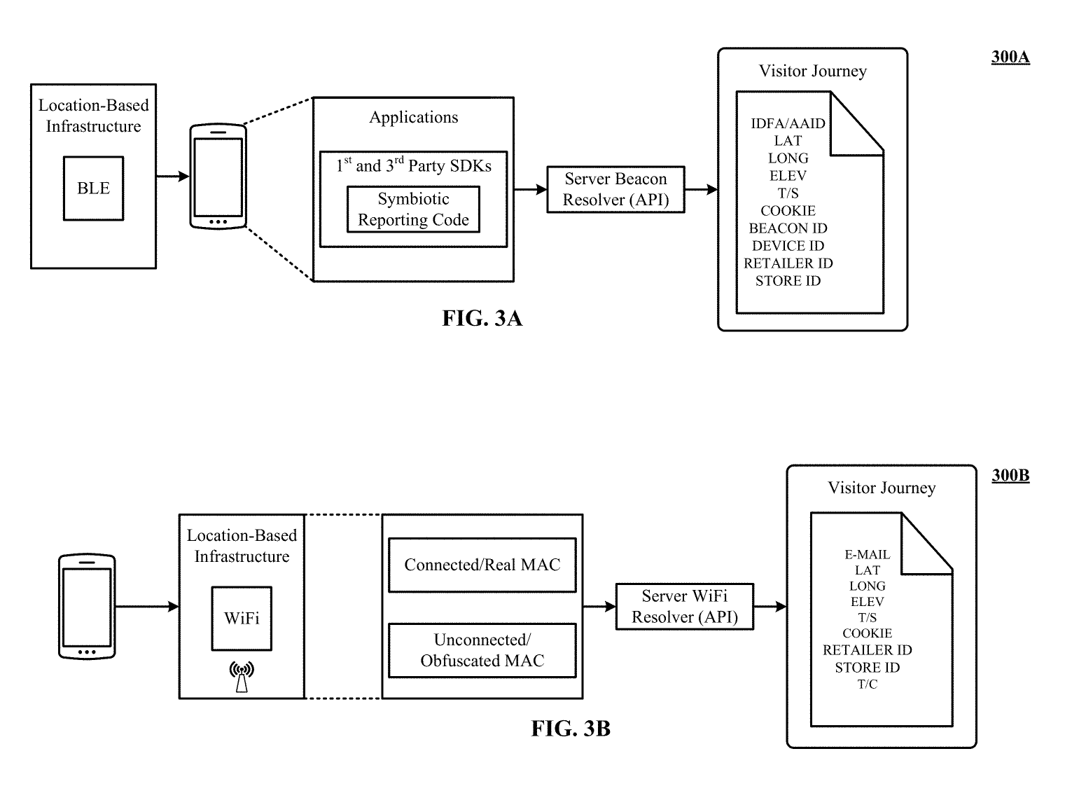

Data processing sub-system also includes an identity resolution component which performs entity disambiguation to populate and update aggregated profiles of user (or shoppers), as described later in this application with reference to FIGS. 3A and 3B. Data processing sub-system also includes a taxonomy component which normalizes product names across multiple retailers using unique product SKUs and creates a bi-directional taxonomy. The bi-directional taxonomy can be used by an analytics environment to determine product specific metrics across the multiple retailers and present such metrics on the frontend using product names that are specific to each of the retailers.

Data processing sub-system also includes a data certification component that enforces compliance of data processing and storage operations with data privacy and authentication regulations such as General Data Protection Regulation (GDPR). Certified data can be stored in a secure data lake. Secure data lake can also store outputs and predictions from the trained machine learning-based models. A visualization environment can access the secure data lake to present various retail and shopper metrics to store operators via dashboards.

Data processing sub-system can interact with the end users (or shoppers) using the external SDK running on client applications active on mobile devices of the end users. One example of such user interaction includes sending a coupon or product recommendation to a shopper. Unprocessed data from the data sources can be stored in the raw data database of the data processing sub-system. Data processing sub-system can use various APIs to communicate with external application servers belong to participating tenants or stores.

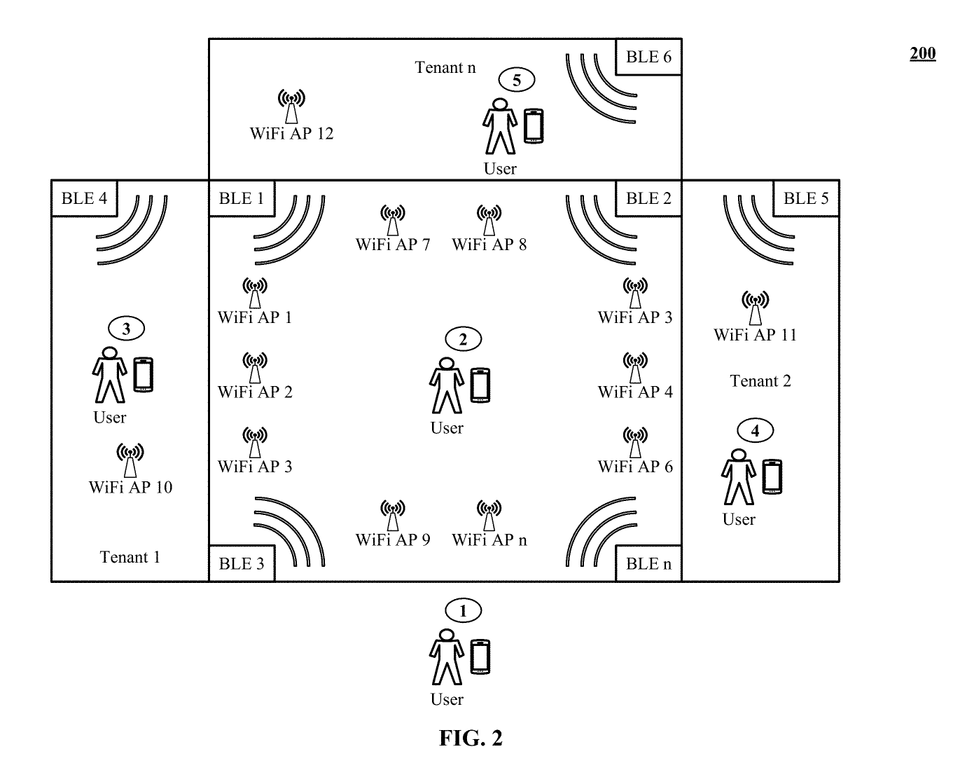

FIG. 2 illustrates tracking of a visitor's journey through tenant locations of a physical venue in accordance with one implementation. In other implementations, the tenant locations are store locations of an independent retailer store that is not in a tenant-landlord relationship. In the illustrated embodiment, physical venue 200 includes three tenants, tenant 1, tenant 2 and tenant three and the visitor's journey is tracked across the three tenants using location-based infrastructure deployed at the physical venue. Examples of location-based infrastructure include Bluetooth Low Energy-based beacons and WiFi access points.

At time 1, the visitor is tracked outside the physical venue 200, for example at a parking lot. At time 2, the visitor's arrival at the physical venue 200 is detected, as well as her departure from the parking lot. At time 3, the visitor's arrival at tenant 1's location is detected, as well as her departure from the tenant 1's location. At time 4, the visitor's arrival at tenant 2's location is detected as well as her departure from the tenant 12's location. At time 5, the visitor's arrival at tenant n's location is detected, as well as her departure from the tenant 2's location.

FIG. 3A depicts location-based infrastructure of beacons deployed to the physical venue of FIG. 1, and a server beacon resolver configured to determine visitor location based on receipt of beacon messages by a mobile device carried by the visitor. In FIG. 3A, symbiotic reporting code, running in active background applications (as part of 1^{st} or 3^{rd} party SDKs), reports and decodes encrypted beacons that the visitor's mobile device otherwise would miss if the visitor did not activate the venue's application or subscribe to the venue's free Wi-Fi. The beacon messages reported by the symbiotic reporting code are received by the server beacon resolver, which serves as an API. The beacon messages 300 include a payload which encodes the visitor journey using data such as IDFA (for iOS devices), AAID (for Android devices), location data such latitude, longitude, elevation, timestep, cookie, beacon ID, device ID, retailer ID, and store ID.

FIG. 3B depicts location-based infrastructure of registered visitor Wi-Fi access points deployed to the physical venue of FIG. 1, and a server Wi-Fi resolver configured to determine visitor location based on receipt of MAC address identifiers by the mobile device carried by the visitor. WiFi access points use real or obfuscated MAC addresses to send data payloads to the server WiFi resolver. These payloads also encode the visitor journey using data such as e-mail, location data such latitude, longitude, elevation, timestep, cookie, device ID, retailer ID, store ID, and terms and conditions.

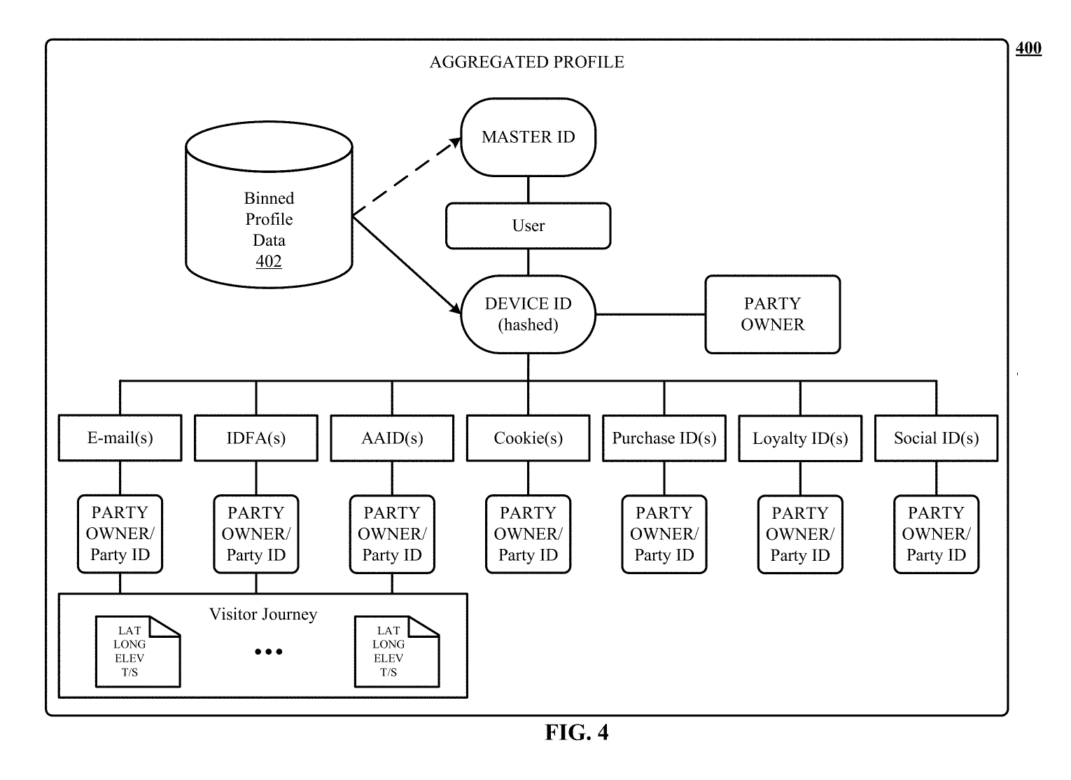

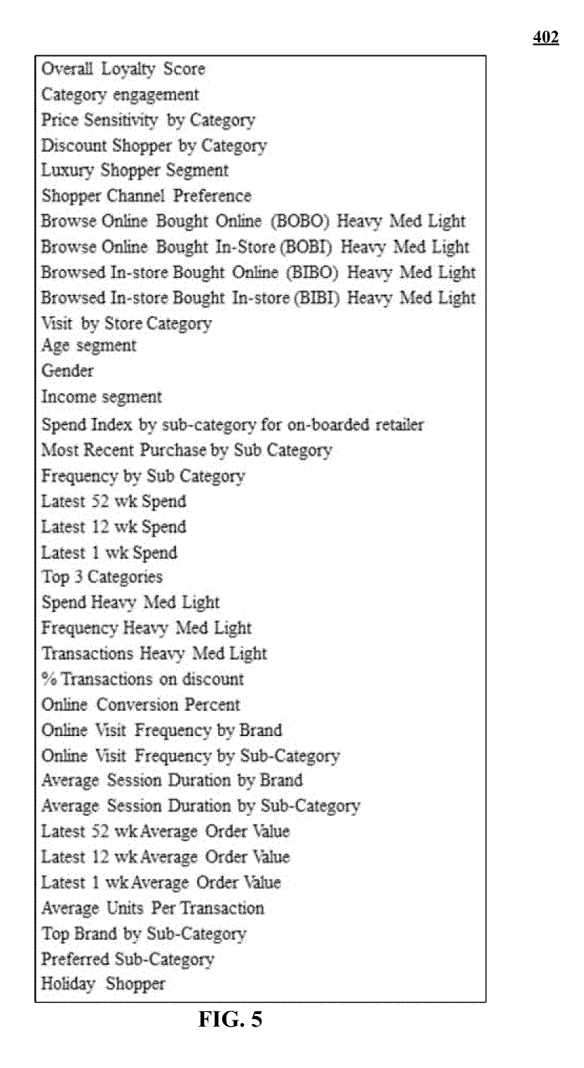

FIG. 4 shows one implementation of an aggregated profile 400 with a master identifier (ID) created for the visitor. When profile and/or location information about a user (or shopper or visitor) is received by the system 100 from one or more data sources, it is assigned a device ID and stored. Device ID uniquely identifies the user associated with the information. The device ID is further tagged with a party owner ID, which identifies the source of the information (e.g., the retail store that provide the information). In some implementations, device ID can be produced by hashing an internal ID used by the retail store to internally identify the user. This way the identity of the user is preserved and is not exposable via the system 100.

In addition, the system 100 assigns a master ID to the device ID. Master ID is used by the system 100 to manage the user's identity and information across many different data sources and retail stores. Binned profile data 402 is linked to the master ID.

Profile and/or location information about the user can be encoded using fields such as e-mail, IDFA, AAID, cookie, purchase ID, loyalty ID, or a social media ID. When the system 100 receives values for these fields, it identifies the source of the value using a party owner ID and also assigns a unique party ID to the value. In some implementations, multiple instances of the same value are received from different sources, such that each value is assigned a different party ID and a corresponding party owner ID.

Also, the e-mail, the IDFA, and the AAID fields are used to track the user's journey, according to some implementations.

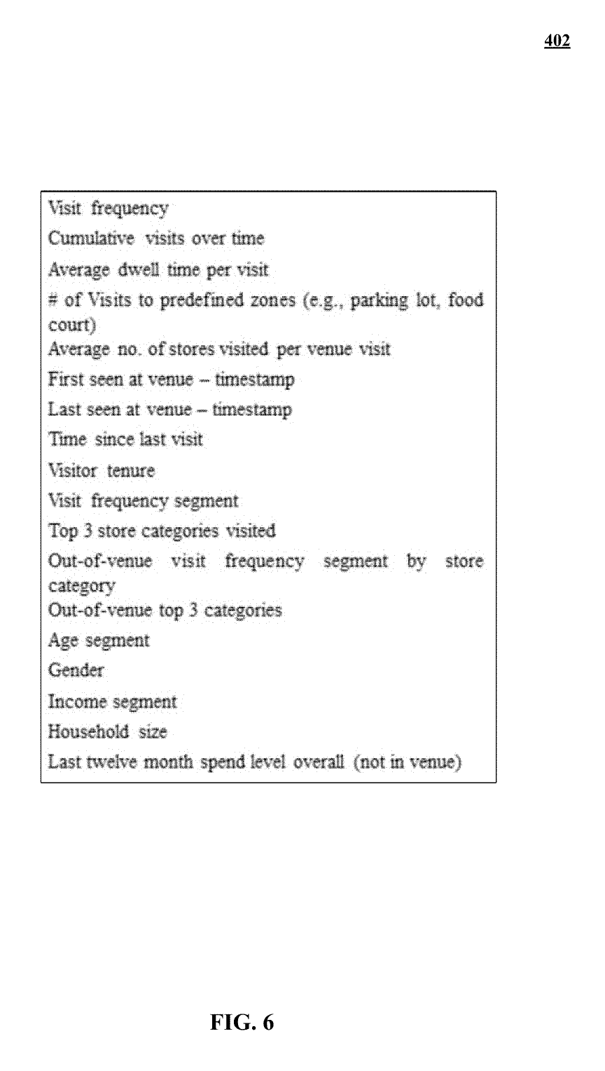

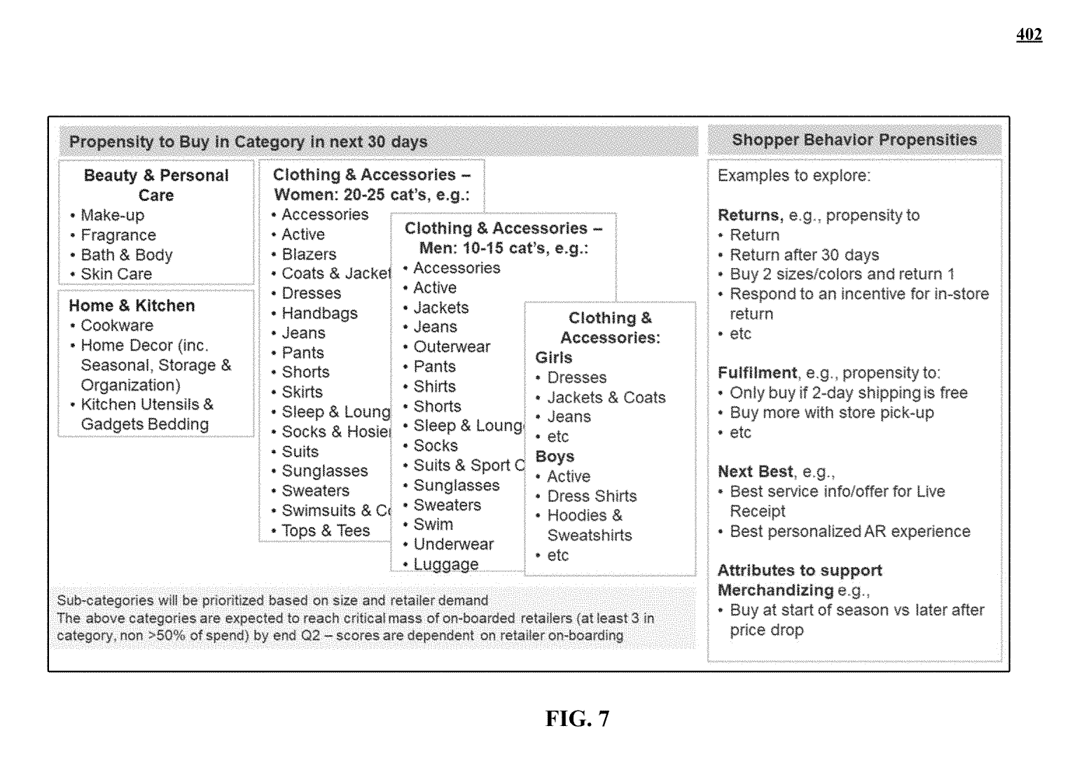

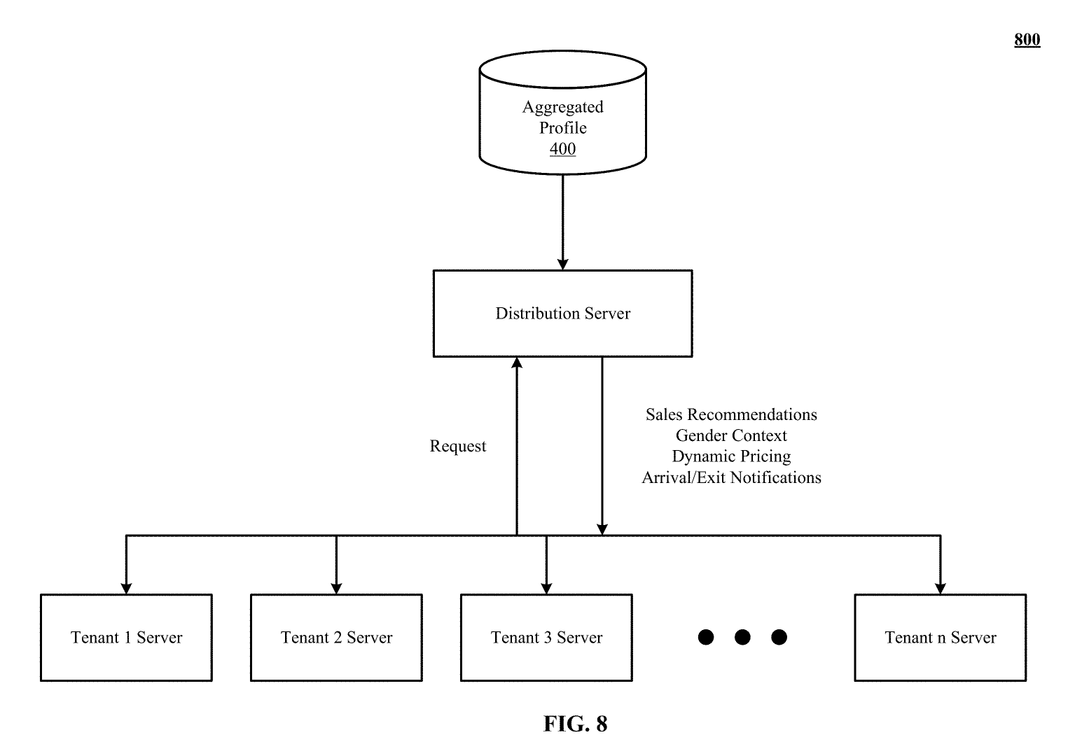

FIG. 5 lists some examples of retailer-related attributes that are included as binned profile data in the aggregated profile 400. FIG. 6 lists some examples of venue-related attributes that are included as binned profile data in the aggregated profile 400. FIG. 7 shows some examples of shopper propensities that are included in the aggregated profile 400.

Regarding dinned profile data 402, it includes tenant-specific binned data individualized for the visitors that represents time-based events in time window bins organized into event categories (e.g., most recent purchase by sub category in FIG. 5). It also includes aggregated binned data individualized for the visitors that also represents time-based events in time-window bins organized into event categories, aggregated across at least the tenants (e.g., latest 52 wk spend, latest 12 wk spend, latest 1 wk spend in FIG. 5). It also includes pre-calculated intent propensities organized by the event categories, generated from the tenant-specific and aggregate binned data (e.g., return propensity, fulfillment propensity, next best propensity in FIG. 7). The aggregated binned data individualized for the visitors further represents time-based events in time-window bins organized into event categories, collected from non-tenant entities (e.g., average dwell time per visit at a venue in FIG. 6). The aggregated binned data individualized for the visitors further includes individual visitor opt-in permissions for location tracking and for messaging organized by data source

FIG. 8 illustrates a distribution server that uses the aggregated profile 400 to send sales recommendations, gender context, dynamic pricing, and/or arrival/exit notifications to participating tenants of the physical venue in response to tenant requests. In other implementations, the participating tenants are participating independent retail stores that are not in a tenant-landlord relationship. The distribution sever can use the visitor journey information encoded in the aggregated profile 400 to report to servers representing the participating tenants of arrival of the visitor, accompanied by a profile of the visitor and tenant-specific and aggregate intent propensity information. The reporting can include a visitor name and other personally identifiable information. The reporting can include a visitor photograph and other personally identifiable information. The reporting can include a unique identifier but not a visitor name or photograph.

As discussed above, binned profile data 402 also includes at least one identified intent of the visitor upon arrival at the venue. The distribution sever can use the intent information encoded in the aggregated profile 400 to report to servers representing the participating tenants of the identified intent. In other implementations, based on an entitlement being fulfilled at the venue, the distribution sever can use the intent information encoded in the aggregated profile 400 to report to servers representing the participating tenants of the identified intent.

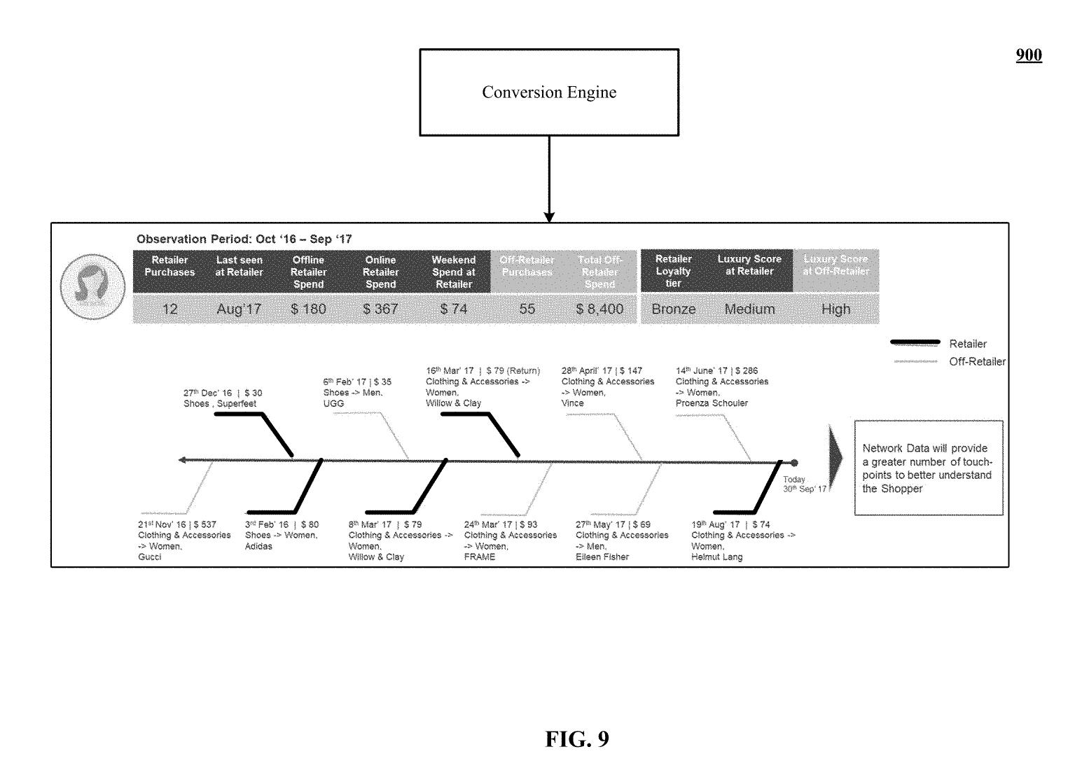

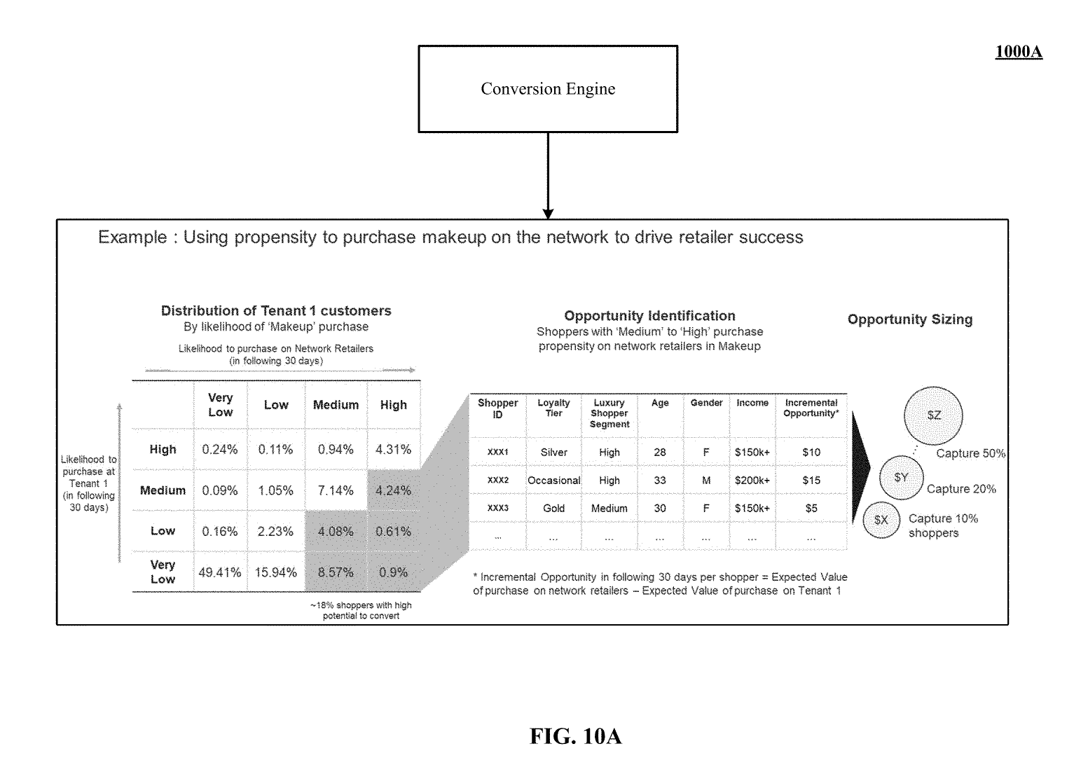

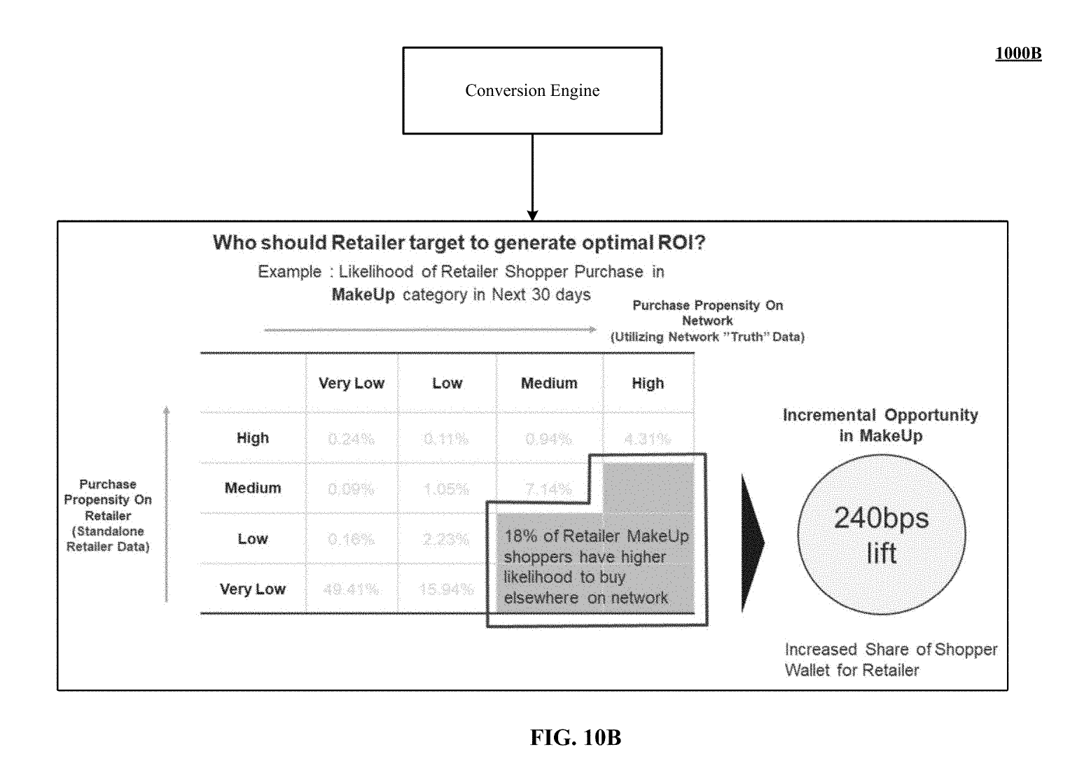

FIGS. 9, 10A and 10B show a conversion engine that uses the aggregated profile of FIG. 4 to identify in-retailer and overall purchase propensities for converting shoppers to in-retailer purchases. In the illustrated embodiment, the system 100 determined that the in-retailer categorization of the shopper is “bronze” based on the shopper's purchase history and spending patterns just at a given retailer. However, upon evaluation of the shopper's purchase history and spending patter at other retailers, the system 100 determines that the shopper is a “high” shopper who has spent much more at the other retailers. The given retailer is informed of this insight via the distribution server and given an opportunity to attend to or target the shopper with more vigor so as to capture more of the shopper's business.

In FIGS. 10A and 10B, system 100 identifies shoppers that have a high potential to convert to a given tenant. System 100 does this by determining that certain shoppers spend much more on a product (e.g., makeup) at other retailers and spend much less on the same produce at the given tenant. The given tenant can be informed of this insight via the distribution server and given an opportunity to attend to or target such shoppers with more vigor so as to capture more of the shopper's business. In implementations, such an insight is provided proactively using the shoppers' purchase history so that the given tenant can lauch a marketing or advertising campaign aimed at such high-value shoppers.

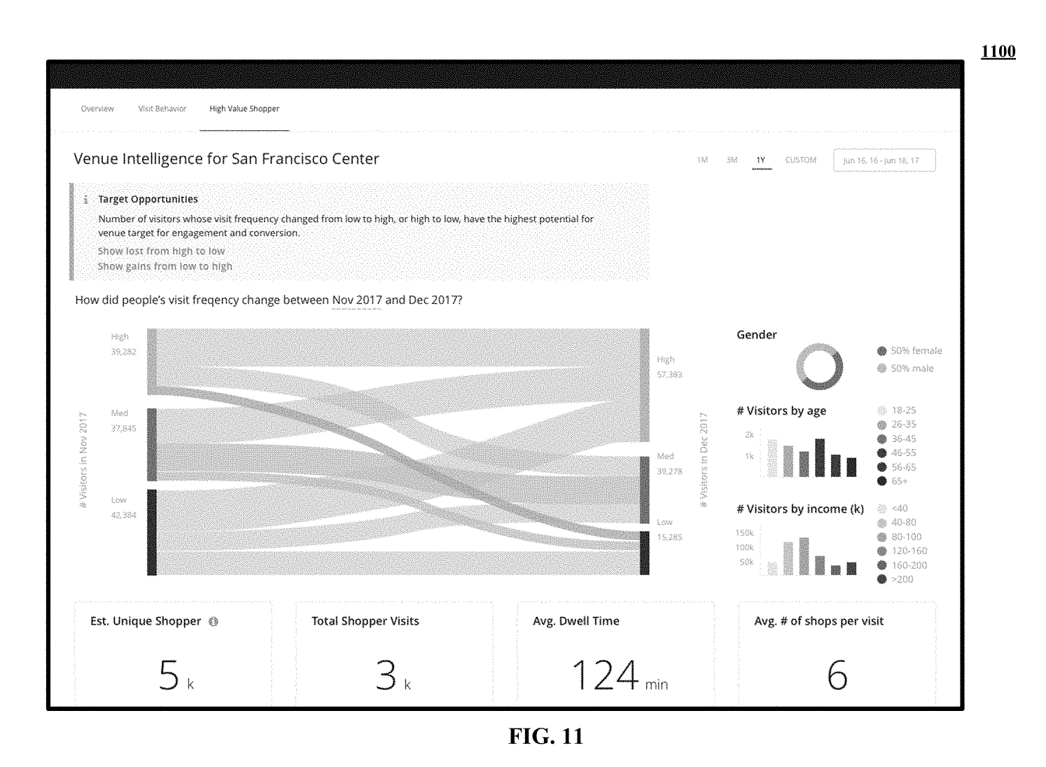

FIG. 11 depicts one implementation of a dashboard that graphically presents various venue intelligence metrics to a venue operator. The time period for this display is one year. The main graphic in the display shows how visit frequencies change between November, 2017 and December, 2017. The overall trend is that more visitors converted from the low to the high visitation frequency category, which would be expected with the approach of holidays. Additional graphics indicated the gender, age and income of visitors. Statistics across the bottom indicate the estimated number of unique shoppers, the total shopper visits, the average time at the venue, and the average number of shops visited per journey. Aggregated profiles for these 5000 shoppers can be configured to retain binned data of this sort. Alternatively, event records can be queried to produce this kind of display.

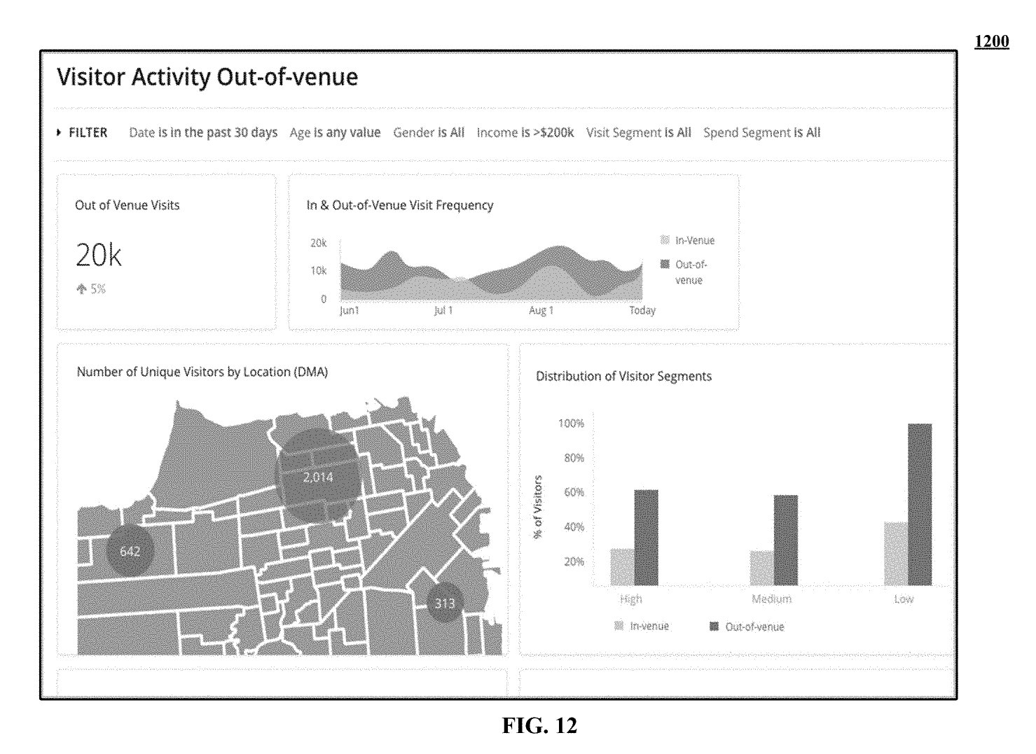

FIG. 12 illustrates one implementation of a dashboard that graphically presents various visitor activity metrics to a venue operator. This display compares in-venue to out-of-venue activity. This display is filtered by time and income. It reflects 20,000 out-of-venue visits in the past 30 days by persons who also visited the venue, which is a 5% uptick from an earlier month. A wave graph for June through December shows the relative frequency of in- and out-of-venue visits by these known visitors. The graph in the bottom left corner indicates where some of the visitors came from. The final graph indicates a distribution of visitor segments. Because this display shows daily or weekly frequencies, it is constructed from event records.

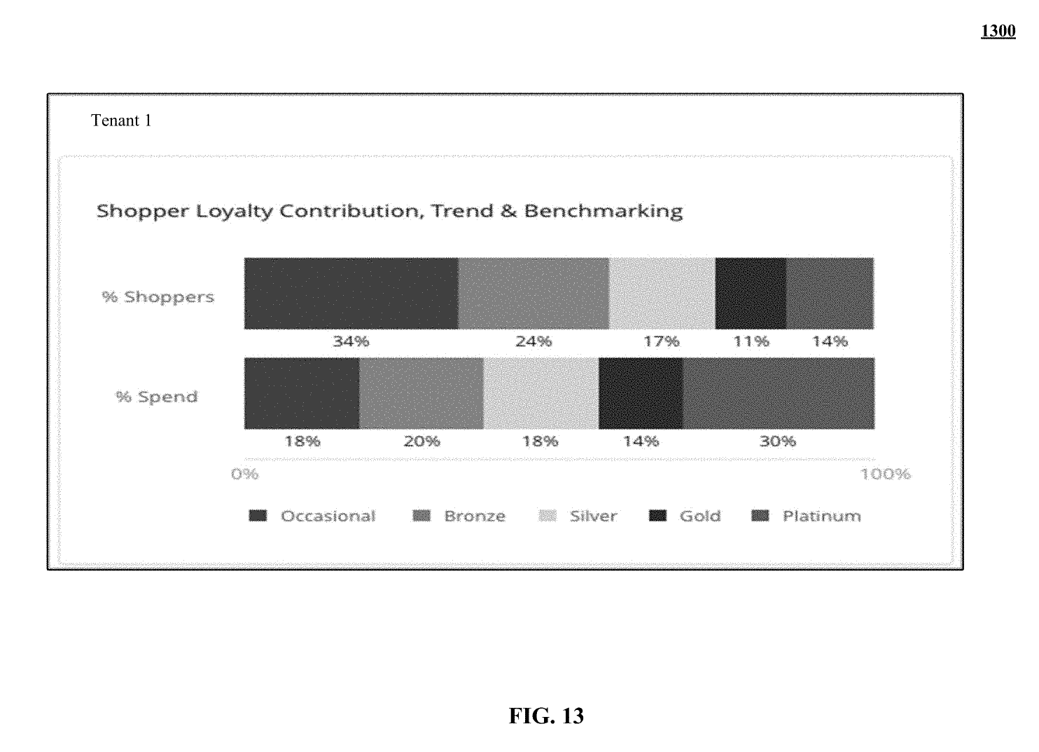

FIG. 13 is one implementation of a dashboard that graphically depicts various shopper attributes across a plurality of shopper stratums. This graph indicates the relative revenue produced by visitors with different ranks of shopper loyalty. This graph organizes shoppers by occasional, bronze, silver, gold and platinum categories. While the platinum category accounts for only 14% of the shoppers, those shoppers generate 30% of this retailer's revenue, at least at one location. A dashboard like this encourages devotion of extra attention to platinum shoppers.

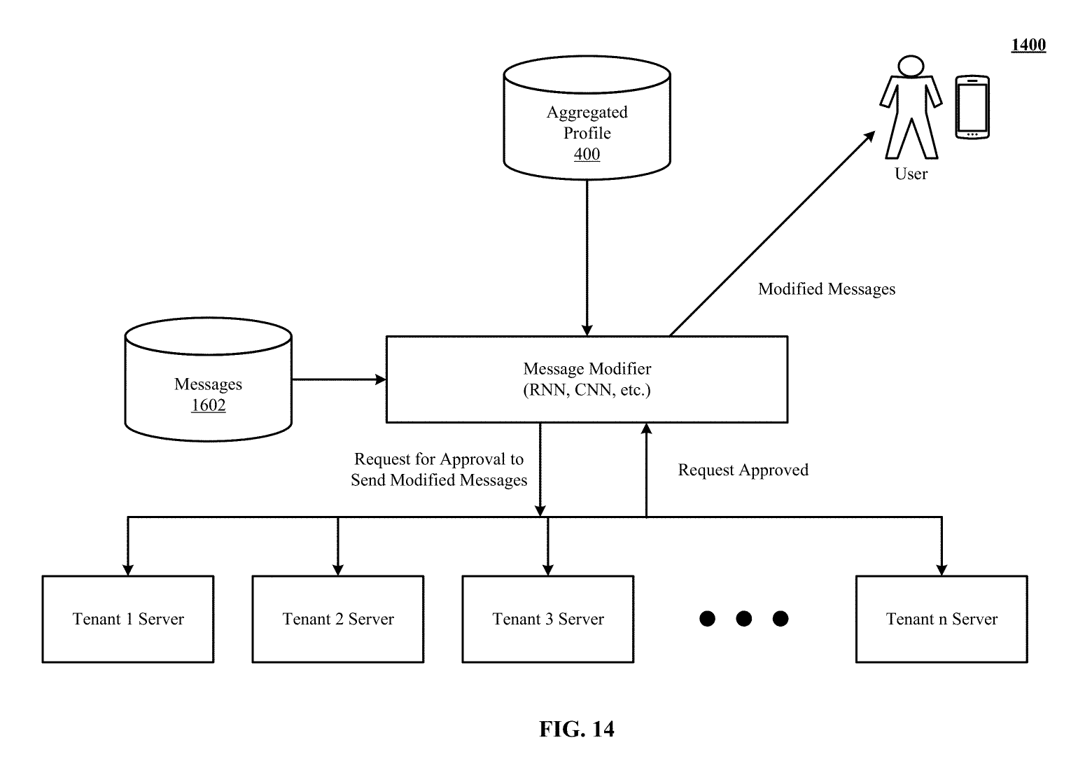

FIG. 14 illustrates a message modifier that uses the aggregated profile 400 of FIG. 4 to determine shopper intent and propensities, and in response, to modify messages and engagement schemes used by the tenants to interact with the visitors. The technology disclosed can be applied to tenants working with a common venue operator, or to independent retail stores in a shopping district who own their own buildings or have different landlords, or to sublocations within a single venue, such as exhibit areas in a museum or wings of an historic or public venue. Messages or message templates 1602 are selected or received by a message modifier. The identity of a target user or visitor is conveyed by the message modifier, along with information from the aggregated port profile 400, to servers representing multiple tenants at the venue. An artificial intelligence system may further process data regarding recent activity by the user, in view of binned data in the aggregate profile. This processing can modify intent propensities precalculated in the binned data to take into account the course of a journey or recent online browsing. Modified intent propensities can be part of the data conveyed to the servers representing multiple entities. The message modifier determines which of the proposed or candidate messages from tenant servers will be sent as modified messages to the user or visitor.

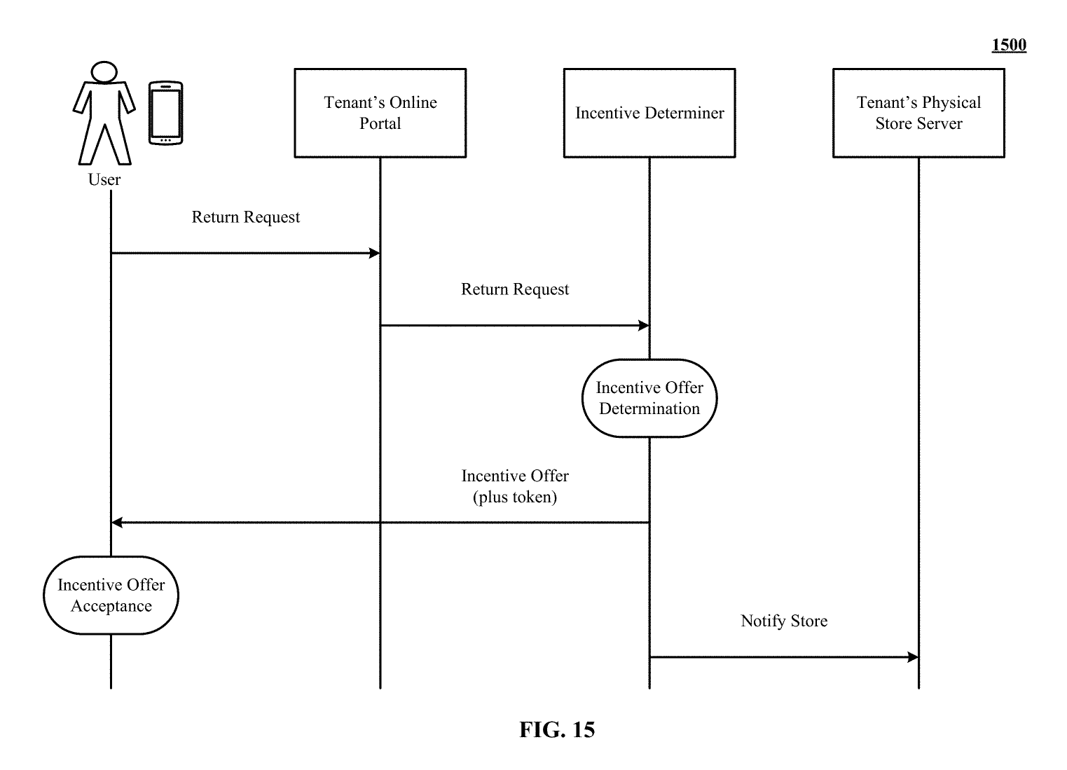

FIG. 15 is a message sequence chart of determining an incentive offer for a shopper using the aggregated profile 400 of FIG. 4 and using the incentive offer to cause the shopper to return goods purchased online at a physical location instead of returning the goods by shipping. It is expensive for a retailer to accept returns by shipping. Sometimes, the return destination is different than the fulfillment destination. In those instances, a restocking fee is charged by the fulfillment agent. It is likely to be less expensive for the retailer to exchange goods at a physical location, for instance by providing a better fitting size. The opportunity to convert a return by shipping to a return in-store arises when a user makes return request to an online portal. The online portal accesses an incentive determination engine. The incentive determination engine uses data in the aggregate profile 400 to assess how much incentive, if any, is likely to convert the user from a return by shipping to a return in store. The aggregated profile 400 contains historic data on propensities of the user to return goods in-store and is liked to additional data, including event data. It also contains binned historic data on return patterns. The incentive determination engine also has access to return processing costs. Reduced return processing costs and opportunities to make an exchange or sell additional goods to the user can be taken into account by the incentive determination engine. Incentive determination engine calculates a maximum incentive for in-store return. This incentive may be modified based on historical data regarding propensities of a particular user. Once an incentive offer determination is made, the offer is returned the user. Upon acceptance of an offer, the online portal for the incentive engine notifies the location at which the return is to take place and provides a token, such as a scannable code, to the user to present at return.

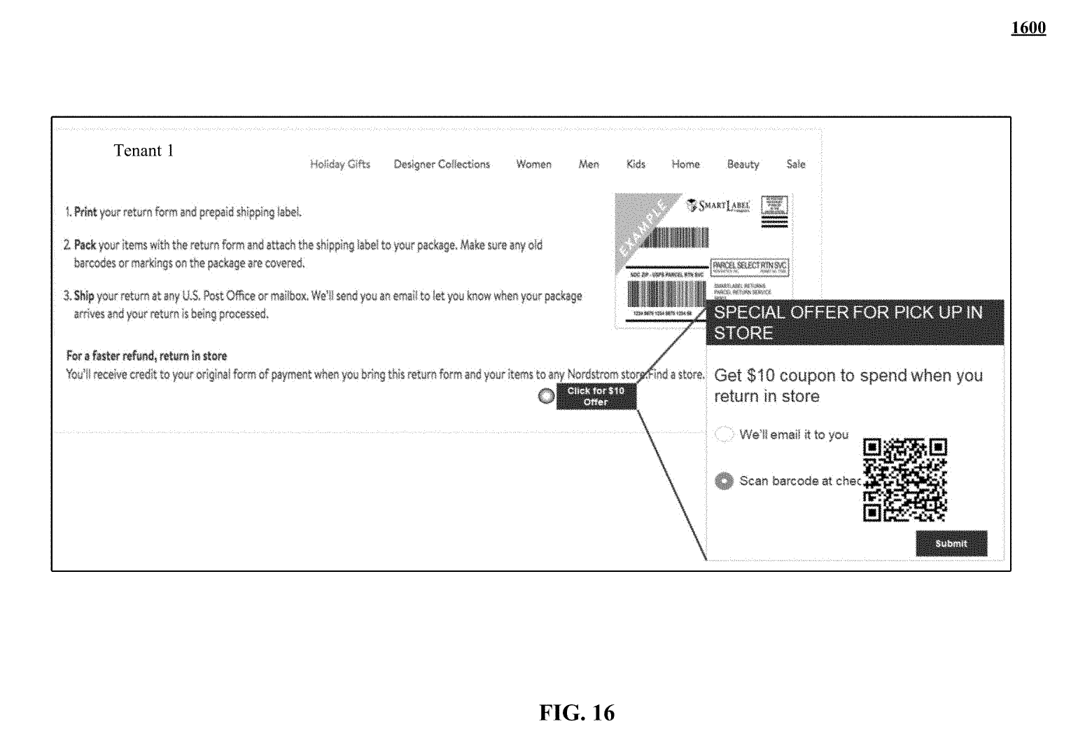

FIG. 16 shows one example of the incentive offer described in FIG. 15. This offer provides a $10 coupon towards additional purchases and a scannable code that can be associated with the return. The scannable code is a token that allows a point-of-sale system to readily accept the return. It also can be used as a coupon, once the return is completed.

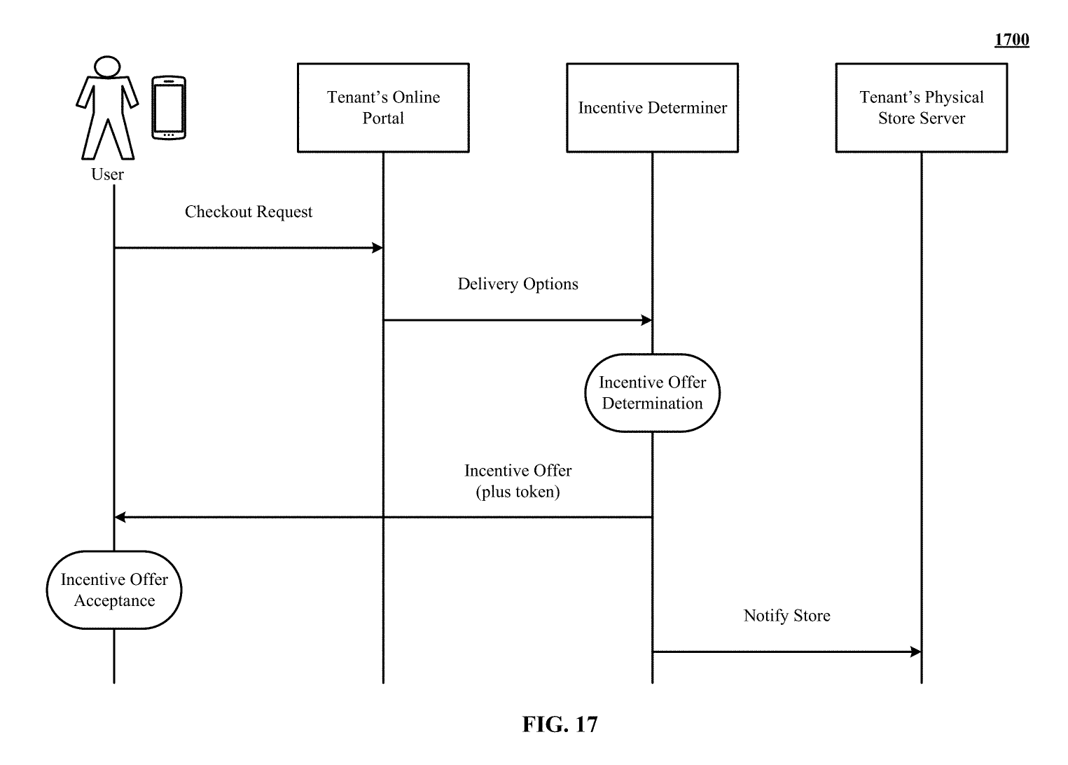

FIG. 17 is a message sequence chart of determining an incentive offer for a shopper using the aggregated profile 400 of FIG. 4 and using the incentive offer to cause the shopper to pick up goods at a physical location rather than request shipping. This works much the same way as returning goods purchased online at a physical location, instead of by shipping. Instead of returning goods, for example for exchange, the user picks up purchased goods. The physical location is responsible for picking the goods and making them available at a pickup counter. In the figure, the online portal, at checkout request, offers the option of in-store pickup. In incentive determination engine uses data in the aggregate profile to assess how much incentive, if any, is likely to convert the user from fulfillment by shipping to picking up goods at a physical location. The aggregated profile contains historic data on propensities of the user to pick up goods from a physical location that are selected and paid for online. Incentive determination engine also has access to fulfillment by shipping costs. Reduced fulfillment costs and opportunities to sell additional goods the user can be taken into account by the incentive determination engine. Incentive determination engine calculates a maximum incentive for in-store pickup. This incentive may be modified based on historical data regarding propensities of a particular user. Once in all incentive offer determination is made, the offers returned to the user. Upon acceptance of an offer, the online portal for the incentive engine notifies the location at which the goods are to be picked up to pull the goods from inventory. It provides a token to the user to present upon arrival at the pickup desk.

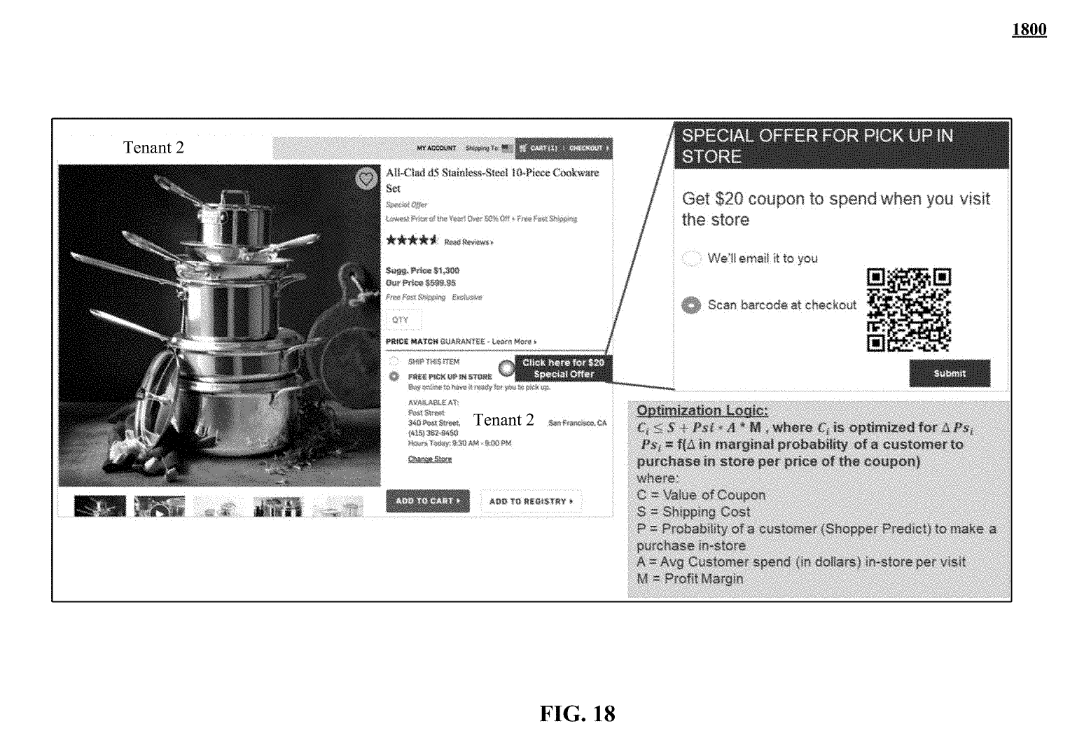

FIG. 18 shows one example of the incentive offer described in FIG. 17. The optimization logic appears in the bottom right-hand corner. The cookware goods being purchased appear prominently in a photograph. The incentive in this example is a $20 coupon to spend while visiting the store. The scannable barcode acts as a token for pickup and can serve as a coupon once the pickup is complete.

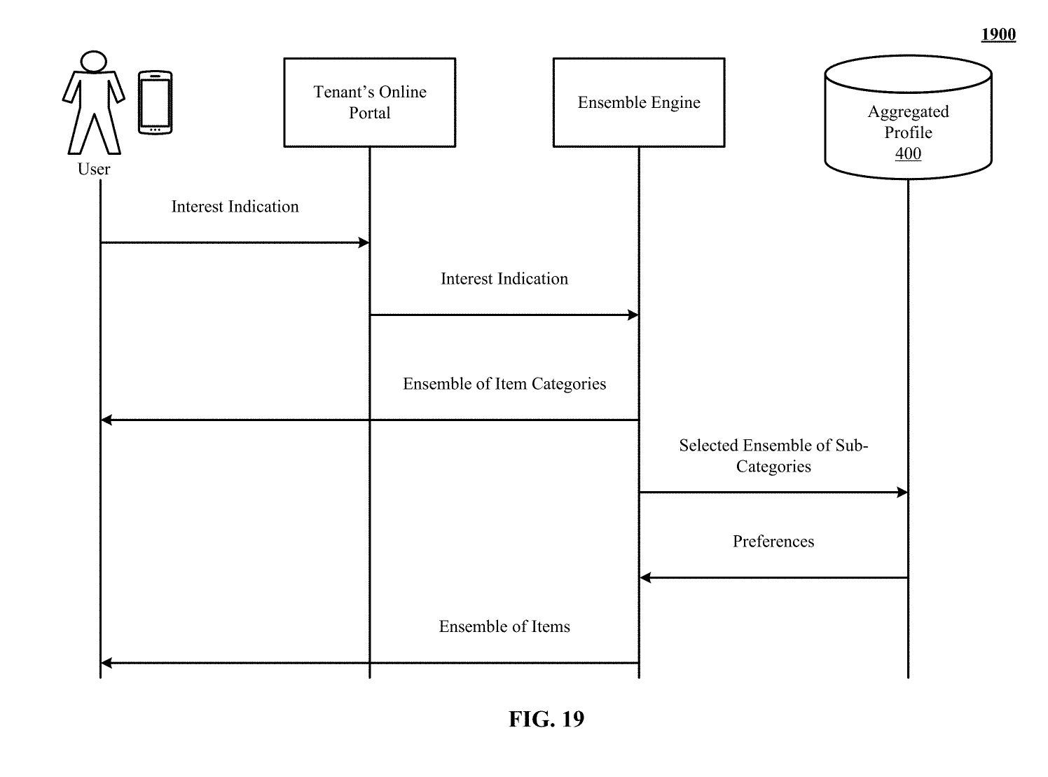

FIG. 19 depicts a message sequence chart of enhancing a user browsing experience using an ensemble engine that generates product recommendations based on a shopper's purchase history, intent and propensity data identified in the aggregated profile 400. When the user access a tenant's online portal (e.g., website) and indicates an item of interest, the portal pings an ensemble engine with with the item of interest. In response, the ensemble engine provides to the user, via the portal, an ensemble of item categories that complement the item of interest. Based on the user's selection of certain ensemble of sub-categories, the ensemble engine looks up the sub-categories in the aggregated profile 400 and retrieves for user preferences. These include category preferences of the user among recommended categories in the ensemble of item categories, feature preferences of the user that apply to the recommended categories, and feature preferences to select items. The ensemble of items selected using the determined category and feature preferences of the user are then presented to the user by the ensemble engine via the portal.

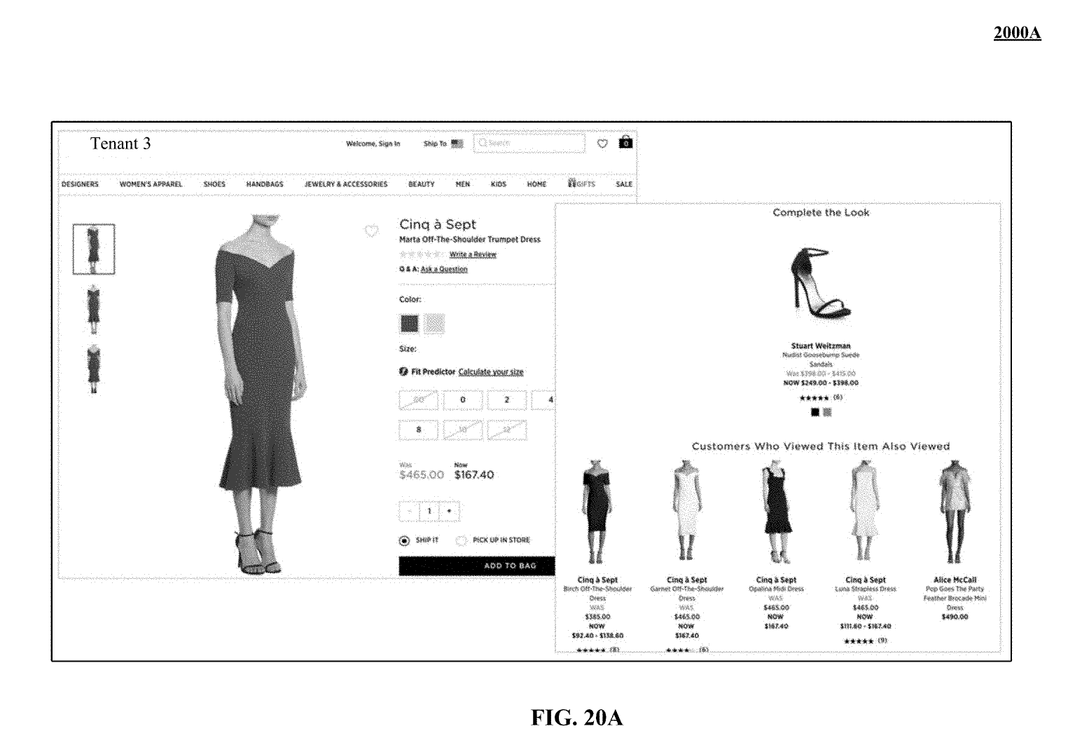

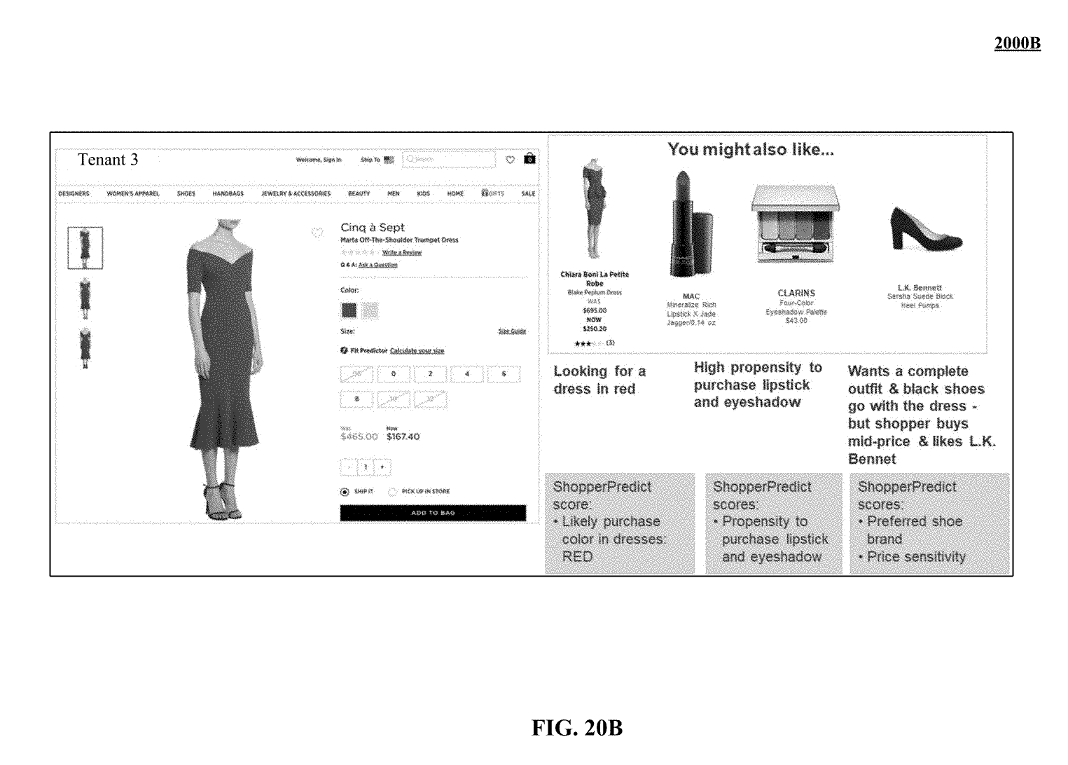

FIGS. 20A and 20B show one example of how the user browsing experience is enhanced by the ensemble engine of FIG. 19. In FIG. 20A, user experience without use of the ensemble engine is shown. In FIG. 20A, the user selected a red dress and is recommended a high heel shoe to complement the red dress. In FIG. 20B, the user experience is enhanced by invoking the ensemble engine. Upon invocation, the ensemble engine determines from the aggregated profile 400 that the user prefers low heel shoes and some other make up accessories (e.g., lipstick, preferred shoed brand, price sensitivity). Based on this information, the recommendations to the user are revised to include product that match the user's preferences.

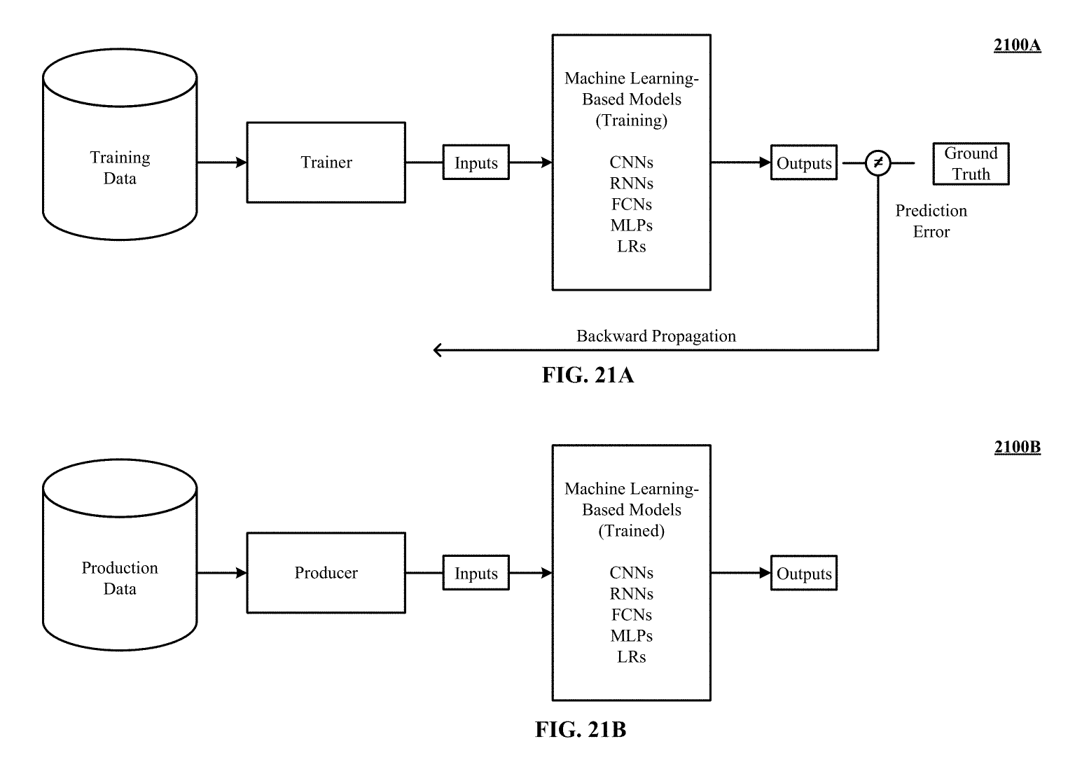

FIG. 21A shows one implementation of a training stage 2100A in which machine learning-based models are trained on training data to output user intent and propensity information. FIG. 21B shows one implementation of a production/inference stage 2100B in which trained machine learning-based models from FIG. 21A are used to evaluate production data and output user intent and propensity information. Examples of machine learning-based models include logistic regression-based models, convolutional neural network-based models, recurrent neural network-based models (e.g., models that use long short-term memory networks or gated recurrent units), fully-connected network-based models, and multilayer perceptron-based models.

In implementations, the machine learning-based models are trained to predict user intent and propensity. The training stage 2100A includes transforming time series of event data using a processor to form a training set (or data). Transformation includes binning hyper-location information by user from physical browsing by the user at a venue having multiple sublocations in time-oriented product category bins, further binning online browsing and consequent conversion history information of a user in time-oriented category bins, and further binning point-of-sale (POS) terminal information by user in the time-oriented category bins. The category bins can be hierarchically arranged from at least dozens of main categories through hundreds or thousands of conversion-specific items. The models are then trained on a combination of the binned online browsing and consequent conversion history, the PoS terminal information, and the hyper-location information to output category intent propensities on a per user basis. In some implementations, the binned purchase amount information is combined with the category purchase propensities and the models are trained using the combination to output an expected product category purchase value on the per user basis. In some implementations, the outputs are generated in dependence upon account seasonal factors.

At the production stage 2100B, the trained models are used to evaluate the production data and output intent and propensity data such as category intent propensities on a per user basis and expected product category purchase value on the per user basis.

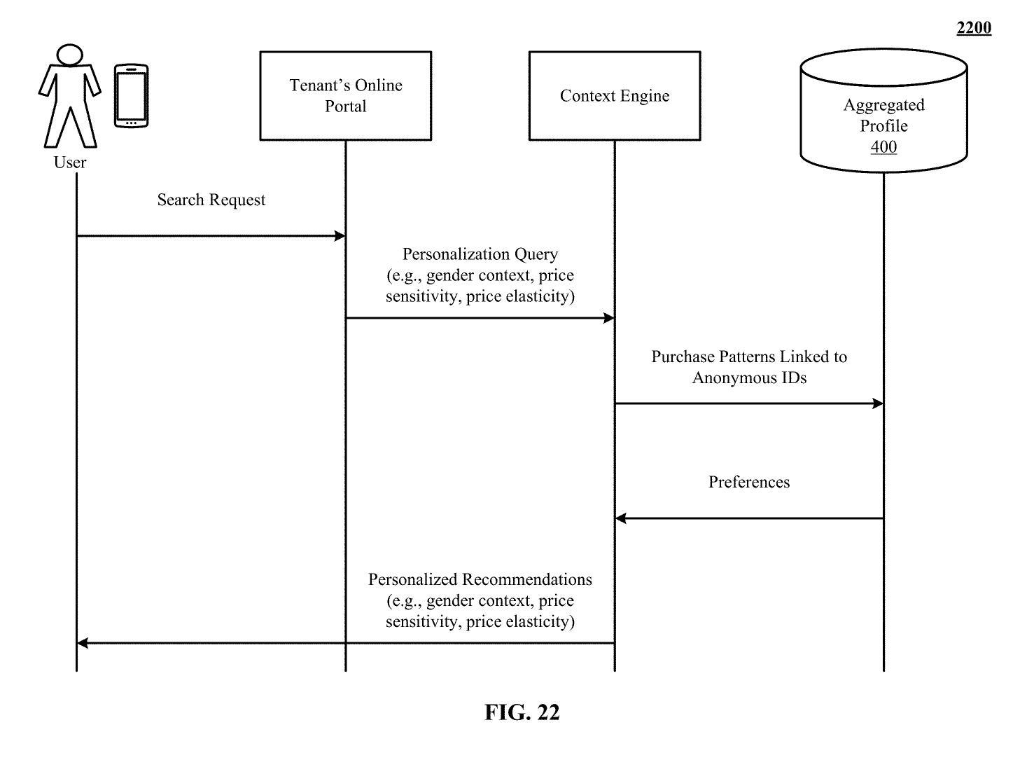

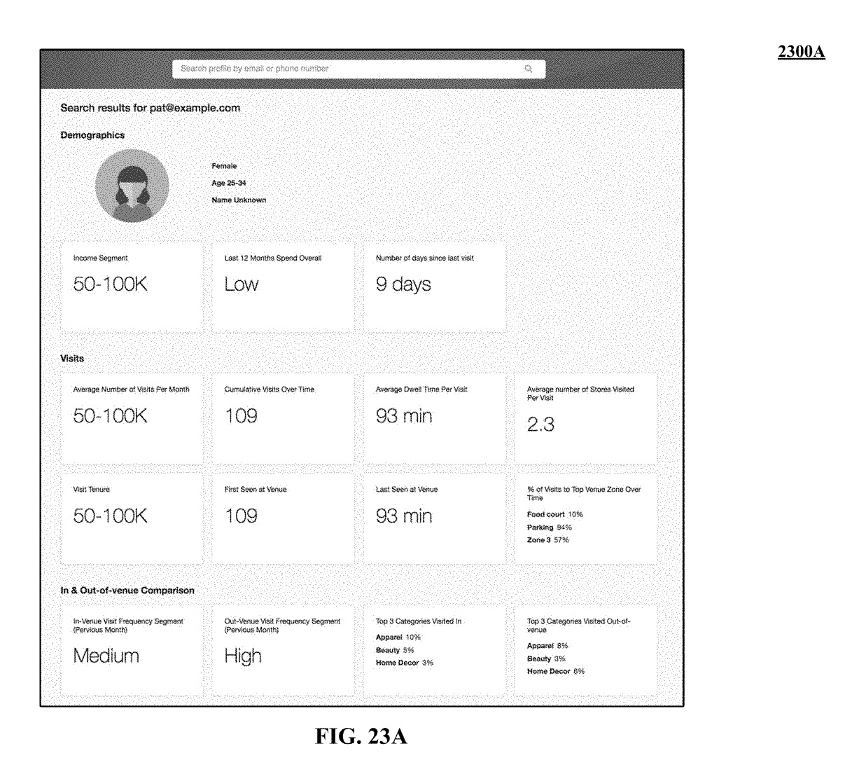

FIG. 22 is a message sequence chart of using the aggregated profile 400 to make personalized recommendations to a shopper. When the user access a tenant's online portal (e.g., website) and searches for a product through a search request, the portal pings a context engine with a personalization query to request some additional context about the user. Examples of user context include gender context (i.e., the user is male or female), price sensitivity context (i.e., what price ranges the user usually makes purchase in), and price elasticity context (i.e., what kind of discounts will propel the user to make a purchase). In response, the context engine access the aggregated profile 400 using purchase patterns linked to an anonymous ID of the user and retrieves purchase preferences of the user from the aggregated profile 400. The context engine then determines personalized recommendations for the user, which are presented to the user via the portal.

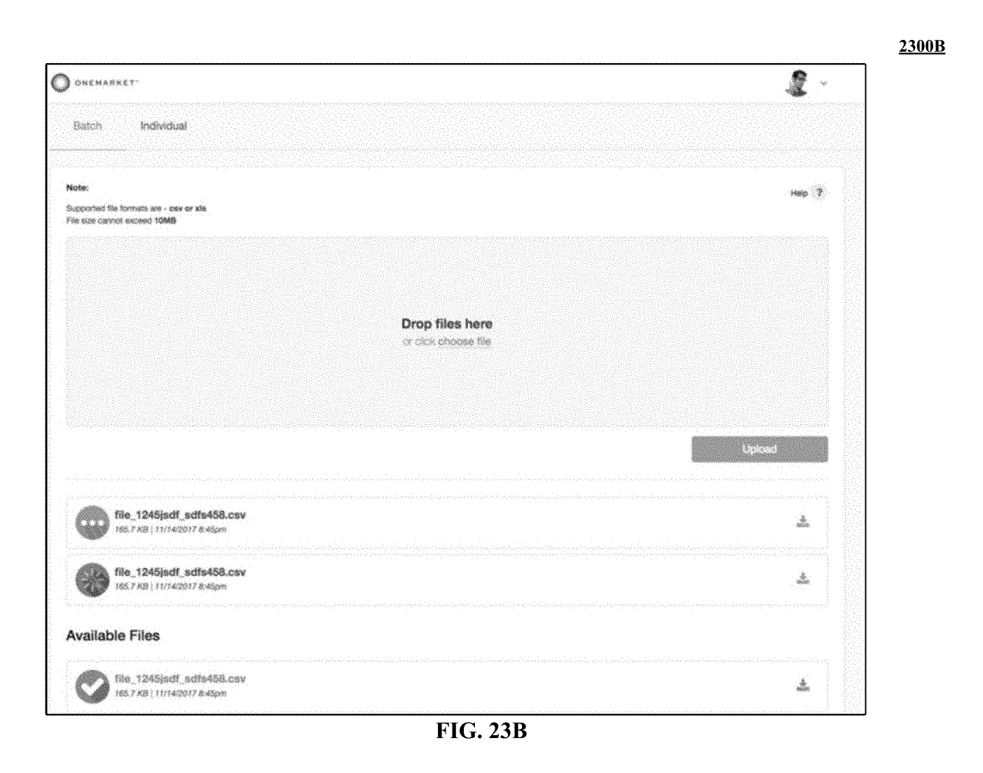

FIG. 23A shows one implementation of a shopper profile 2300A accessible to a retail store operator. Shopper profile 2300A includes various shopper metrics such as biographic information about the shopper, the shopper's income segment, the shopper's purchase history, the shopper's visit history, etc. FIG. 23B is one implementation of an interface 2300B that can be used by a retail store operator to request new or updated shopper profiles. In one implementation, the store operator can use a drag and drop feature to upload a list of shopper to the system 100. In response, system 100 can generate new or recent shopper profiles (such as shopper profile 2300A) for the shoppers identified in the uploaded list and present them to the store operator. The retrieval of a shopper profile can also be for an individual shopper, without the upload requirement.

### Computer System

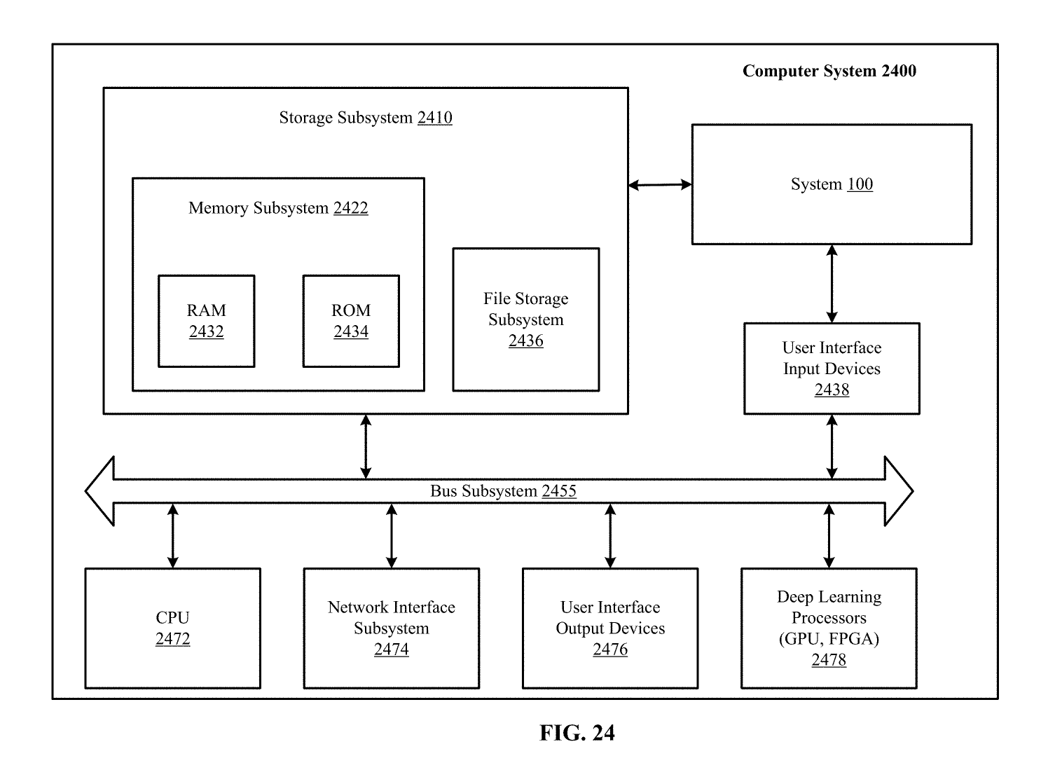

FIG. 24 is one implementation of a computer system 2400 that can be used to implement the technology disclosed. Computer system 2400 includes at least one central processing unit (CPU) 2472 that communicates with a number of peripheral devices via bus subsystem 2455. These peripheral devices can include a storage subsystem 2410 including, for example, memory devices and a file storage subsystem 2436, user interface input devices 2438, user interface output devices 2476, and a network interface subsystem 2474. The input and output devices allow user interaction with computer system 2400. Network interface subsystem 2474 provides an interface to outside networks, including an interface to corresponding interface devices in other computer systems.

In one implementation, the system 100 of FIG. 1 is communicably linked to the storage subsystem 2410 and the user interface input devices 2438.

User interface input devices 2438 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2400.

User interface output devices 2476 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2400 to the user or to another machine or computer system.

Storage subsystem 2410 stores programming and data constructs that provide the functionality of some or all of the modules and methods described herein. These software modules are generally executed by deep learning processors 2478.

Deep learning processors 2478 can be graphics processing units (GPUs) or field-programmable gate arrays (FPGAs). Deep learning processors 2478 can be hosted by a deep learning cloud platform such as Google Cloud Platform™, Xilinx™, and Cirrascale™. Examples of deep learning processors 2478 include Google's Tensor Processing Unit (TPU)™, rackmount solutions like GX4 Rackmount Series™, GX8 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamiclQ™, IBM TrueNorth™, and others.

Memory subsystem 2422 used in the storage subsystem 2410 can include a number of memories including a main random access memory (RAM) 2432 for storage of instructions and data during program execution and a read only memory (ROM) 2434 in which fixed instructions are stored. A file storage subsystem 2436 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2436 in the storage subsystem 2410, or in other machines accessible by the processor. Bus subsystem 2455 provides a mechanism for letting the various components and subsystems of computer system 2400 communicate with each other as intended. Although bus subsystem 2455 is shown schematically as a single bus, alternative implementations of the bus subsystem can use multiple busses.

Computer system 2400 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 2400 depicted in FIG. 24 is intended only as a specific example for purposes of illustrating the preferred embodiments of the present invention. Many other configurations of computer system 2400 are possible having more or less components than the computer system depicted in FIG. 24.

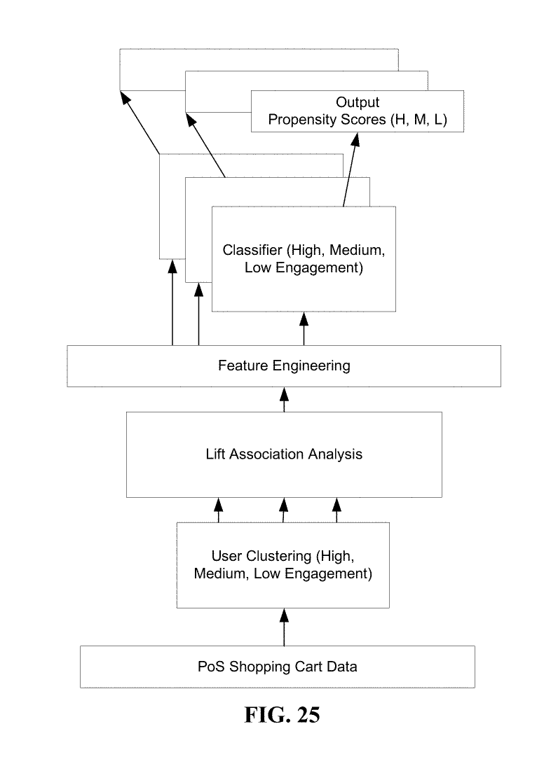

FIG. 25 shows a block diagram of a purchase propensity predictor that produces user purchase propensity scores. A user propensity score is likelihood that a user will purchase an item from a dependent category at a future time. The predictor uses time binned input data, collected from PoS terminal shopping cart data during an analysis period, to predict the propensity score. The binned input data comprise data from online and offline purchases as well as online browsing and offline browsing, standardized using common identity resolution and product taxonomy. An example analysis period may be 12 months, with input data grouped into daily/weekly/monthly input time bins. The propensity score predicts a purchase occurring within a result time bin. For the analysis period of 12 months, the result time bin may be a current month. Offline browsing data comprise data from personal devices with location sensing capabilities, such as smartphones and wearable devices. The location-specific data have detailed knowledge of a visitor's journey and visitation patterns in an indoor venue. The personal devices can estimate their locations through beacons, communications with one more GPS satellites, proximity to one or more WiFi sources, multilateration of radio signals between several nearby cell towers, IP addresses of the personal devices, and so on. The location-specific data may be collected by the indoor venue through beacons and WiFi access points inside the indoor venue. The location-specific data may also be obtained from third-party vendors.

The propensity predictor of FIG. 25 has four stages: empirically derived user clustering for customer segmentation, category affinity analysis to inform variable reduction, feature engineering for pattern recognition, and finally classification for purchase likelihood prediction. In the implementation of FIG. 25, user clustering is performed prior to category affinity analysis. The output of the user clustering is used for category and variable reduction/selection in category affinity analysis. In other implementations, user clustering may be performed after category affinity analysis. Two classification implementations are described in this specification: an extreme gradient tree boosting implementation (XGBoost) and a long short-term memory (LSTM) network implementation.

During the user clustering stage, users are clustered using a method called Recency, Frequency, Transaction Purchase interval (RFT) Analysis by implementing k-means clustering algorithm. By this method, users are given Recency, Frequency, and Purchase interval scores based on purchase and browsing information the retailer collects from the users over the analysis period. A user's recency score is equal to a count of time bins from the result time bin back to a most recent time bin within the analysis period in which the user made a purchase. For example, if data is binned monthly, and a user bought a dress during the current month, that user's recency score would equal zero. If the user hadn't made a purchase in four months, the user's recency score would equal four. A user's frequency score is the number of transactions that user has completed since the beginning of the analysis period. Lastly, a user's purchase interval score is the average time in days between purchases through a period of time, for example over twelve months, over six months and so on. Based on these RFT scores, the users are clustered into engagement groups of high engagement, medium engagement, and low engagement users based on their scores in all three areas, in this case done using KMeans clustering.

In one implementation, RFT clustering produces engagement groups with the following characteristics. High engagement customers have recency scores within the ˜50^{th} percentile range of scores (the highest 50% of R scores), purchase interval scores within the ˜50^{th} percentile (the highest 50% of F scores), and frequency scores above the 25^{th} percentile (the highest 25% of M scores). Medium engagement customers have recency scores between the 1^{st} and 49^{th} percentiles, purchase interval scores between the 1^{st} and 49^{th} percentiles, and frequency scores between the 1^{st} and 24th percentiles. The remaining customers are placed in the cold start group comprising of customers that have not previously bought in the category of interest.

The category affinity analysis stage helps in determining independent categories of items that are used for variable reduction and subsequently determine features analyzed by the classifier to produce a propensity prediction for the dependent category. Treated as an extension of market basket analysis in order to accommodate physical as well as digital shopper behavior, category affinity analysis first identifies shopper who have purchased in a dependent category. The category affinity analysis then looks at their other purchases at a transaction level in other categories across different time horizons, and picks the optimal time horizon based on the decrease in net new categories. Then, based on the category association score, independent categories are identified for input into feature engineering. Independent categories are categories of items which most strongly lift sales for items from the dependent category. For example, if the dependent category is dresses, independent categories may include categories within the parent Womens Clothing category such as skirts, rompers, capris, evening attire, and blazers or in other parent categories such as Mens Clothing, Home and Kitchen etc. The propensity predictor chooses independent categories by calculating the lift values of the individual independent categories with the dependent category, and selecting a predetermined number of highest-lift independent categories.

For any two categories A and B, the lift is calculated using the formula:

$$Lift = \frac{supp ( AB )}{supp ( A ) \times supp ( B )}$$

The supp( ) term refers to the support, or proportion of purchase transactions (irrespective of distinct SKUs), for items in each category: supp(A) represents the proportion of purchases containing items from category A (or support of A), supp(B) represents the proportion of purchases containing items from category B, and supp(AB) represents the proportion of purchases containing items from both categories.

The lift between two categories implies whether or not probabilities for purchasing items from the two categories are independent of one another, based on the observed support for items in both categories. If two categories have a lift greater than one, the probabilities of purchasing items from both categories are implied to be dependent. In other words, items from categories with large lift values are more likely to be bought together. For example, rompers have a high lift with dresses. Both types of garments have similar functions, so users who purchase rompers are likely to also purchase dresses.

During the feature engineering stage, the propensity predictor determines features for the machine learning model using category-specific shopping cart data from the dependent and independent categories, as well as cross-category shopping cart data and customer level features. The selected features are tabulations that represent user characteristics that relate to retail transactions. Features may include purchases, browsing, returns, and discounts received.

Some features are time-binned, or grouped based on specific time intervals (within the analysis period) into which they fall. For example, for a set of monthly time bins, a purchase occurring on February 26 would be placed in a February time bin. Cross-category time-binned features include total dollars spent last July, number of transactions last May, and total monthly discount amounts on all items purchased last December. Category-specific time-binned features include February spending on dresses and number of skirts purchased last September.

Some time-binned features relate specifically to user browsing. Browsing is done in-store or online. Browsing data features are used as inputs to both the extreme gradient boosting and the LSTM classifier implementation. Browsing data may be category-specific or cross-category. Examples of browsing data include visits to the women's shoe department four weeks ago, or total web page visits three weeks ago.

Other features are not time-binned, but summarize user characteristics for the whole analysis period. These features may also be either category-specific or cross-category features. Examples of these features include how recently a user visited a retailer, a user's average time interval between dress purchases, discount versus luxury shopper etc.

The classifier calculates purchase propensity scores for users in an engagement group by analyzing the input features. A propensity score may be expressed as a probability between zero and one. Values close to one indicate that users are likely to purchase items from the target category in the prediction period. Values closer to zero indicate that users are unlikely to purchase items from the target category in the prediction period. The probabilistic value may be transformed using a scaling function which could render the final score between 0 and 1000 for example. Scaling is a cosmetic transformation of the probabilities output by the machine learning algorithm to make the scores easier to consume by the end user.

The classifier is trained in order to be able to make accurate predictions. During training, the classifier calculates a propensity score for the dependent category by analyzing a set of training data. Training data may include time-binned as well as not time binned input features. The calculated propensity score is evaluated against a ground truth or observed values. The ground truth for the classifier may be a binary value representing whether or not a user made a purchase during the result time bin. For example, a ground truth may be equal to zero or it may be equal to one, for a binary classifier outputting propensity scores between zero and one. Training may be performed for several epochs, or iterations of analysis of all of the input features, and may include extensive hyper tuning of machine learning parameters to best predict likelihood to buy in a dependent category. After training is completed, the model calculates a purchase propensity score for a dependent category from a test set of feature data, in order to predict a dependent category purchase during the result time bin. The model is then validated with both an out of sample and out of time dataset.

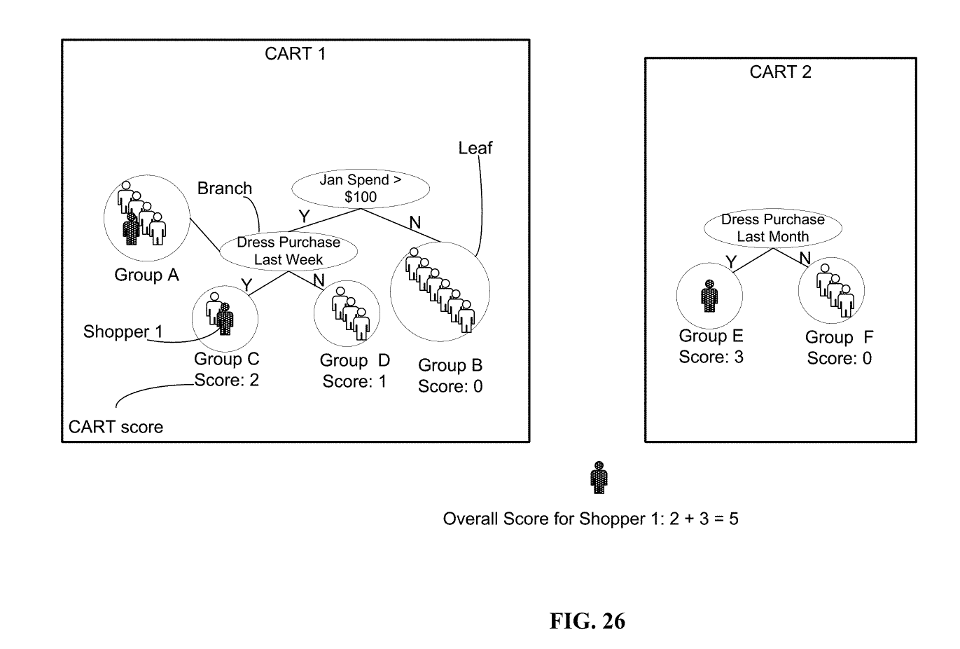

FIG. 26 shows a simplified diagram of a gradient tree boosting algorithm used by the classifier to calculate a user's purchase propensity score for the dependent category. This algorithm uses an ensemble of classification and regression trees (CARTs). Each CART calculates its own purchase propensity score for the user, and the algorithm adds the scores from all of the CARTs together to create an overall purchase propensity score for the user.

A single CART splits users into multiple groups using decision rules. Each split forms a branch of the tree. Each branching decision creates new nodes in the CART, called leaves. Terminal leaves are given scores, applied to all users in that leaf, which are used to classify the users.

The classifier does not use a single CART because the number of user input features being analyzed is too large. Using a single CART on such a large set of data requires a complex tree structure with many branches and leaves. An overly complex machine learning model is likely to overfit data after it is trained, resulting in a model with little predictive power. In addition, such a complex model is more likely to make unstable predictions, as larger models have larger variance.

Gradient tree boosting mitigates these problems by minimizing error in estimation and then calculating propensity scores from many CARTs. Gradient tree boosting configures each CART's size to balance prediction accuracy and complexity, which both increase as new leaves are added. Before a branching decision is made for a CART in order to add new leaves, the classifier calculates the additional accuracy and complexity that would be produced by adding the new leaves. If the increase in complexity is larger than the gain in accuracy, the leaves are not added to the CART. Instead, the classifier retains the CART's scores and builds a new CART, applying the same accuracy-complexity criteria to grow the new CART and determine additional CART scores. Once all of the CART scores are calculated, they are added together to produce an overall user score. An activation layer then converts the overall user scores to purchase propensity scores. Using this method of gradient tree boosting results in a classifier that has high predictive power and low complexity.

In this implementation, the features analyzed by the gradient tree boosting algorithm are monthly, weekly and daily time-binned user characteristics. Additional cumulative monthly features are calculated to be analyzed by the classifier. For example, a “last four months' spend” category is calculated by summing individual user spending values from the four input time bins prior to the result time bin. The classifier analyzes the time-binned features during a single input cycle in order to produce a propensity score.

FIG. 26 shows a simplified example of gradient tree boosting being used to calculate a shopper's purchase propensity for a dress. FIG. 26 shows two CARTs, with an overall score for Shopper 1 determined by summing a score for Shopper 1 from CART 1 with a score for Shopper 1 from CART 2. CART 1 has two decision branches. CART 1 splits the population of users into leaf A if they spent more than $100 on clothes in January, and into leaf B if they spent less than $100 on clothes in January. Then, CART 1 splits the leaf A users into two leaves: C and D, where group C users purchased a dress last week and group D users did not. The users in leaves B, C, and D are assigned CART scores of 0, 2, and 1, respectively. Shopper 1 receives a score of 2. CART 2 has one decision branch, splitting users into groups E and F based on whether or not they purchased a dress last month. Shopper 1 is in Group E, and receives a score of 3. Shopper 2's overall score is calculated by summing his scores from CARTs 1 and 2. Shopper 2 receives a score of 5. In order to classify Shopper 1, the classifier uses activation layer to convert Shopper 1's score into a propensity score between 0 and 1.

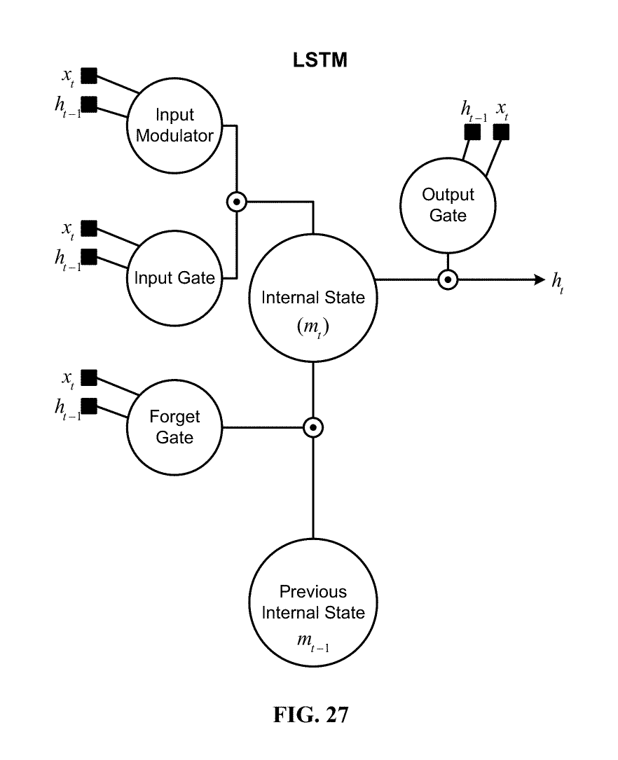

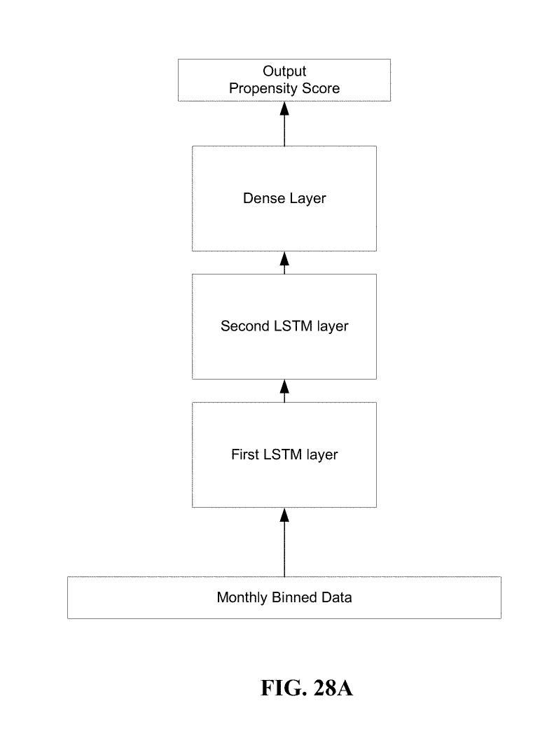

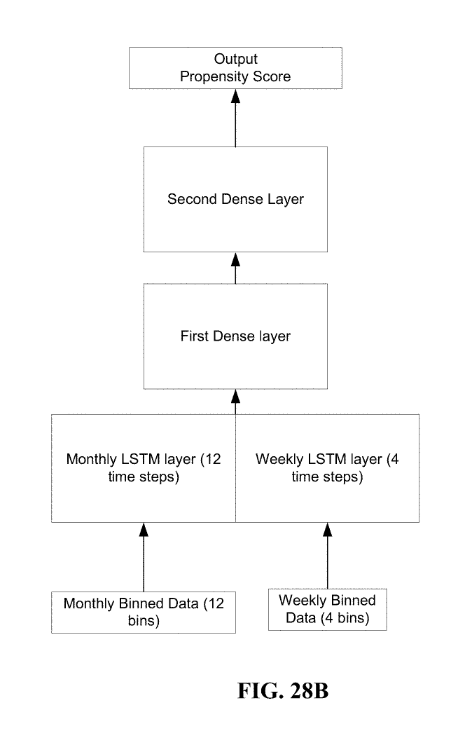

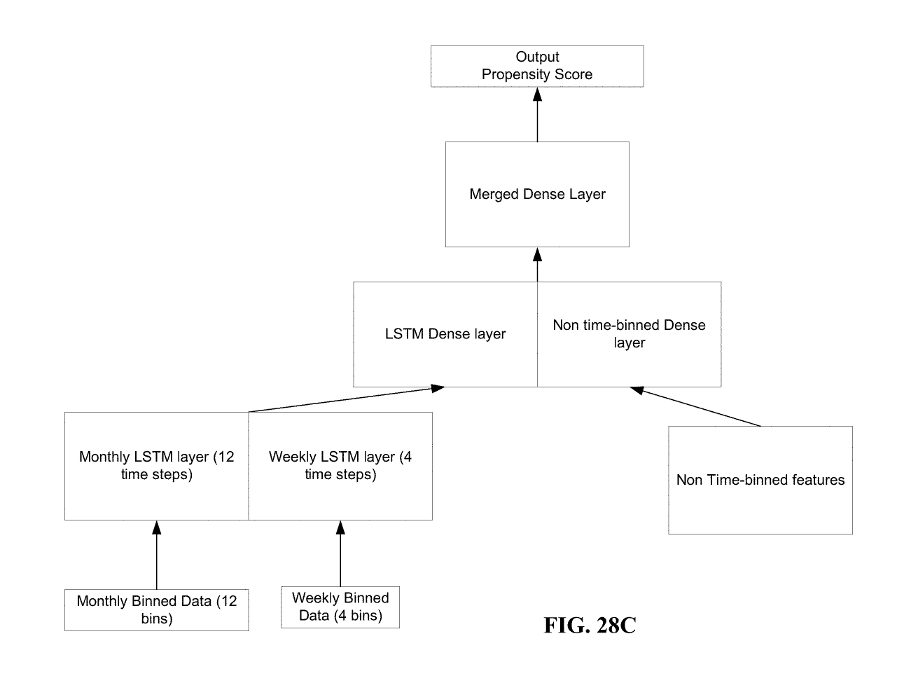

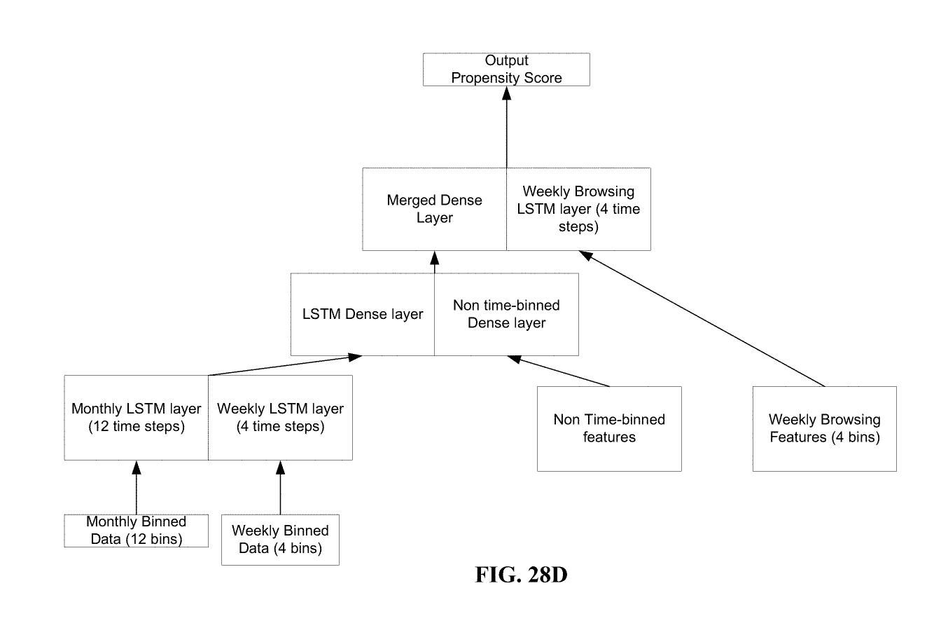

FIGS. 27 and 28A-D show diagrams for a classifier using one or more recurrent neural networks (RNNs) made up of long short-term memory (LSTM) blocks. Unlike other types of RNNs, an LSTM network can selectively “remember” information over arbitrary intervals of time. This property makes the LSTM network a powerful classifier when used to calculate purchase propensities using time series data. For example, the LSTM network can be used to calculate a propensity score for a user to purchase a Santa hat in December. The user purchases a Santa hat every December, shortly before Christmas. Although the user does not purchase Santa hats often, the user has a high propensity to purchase the hat this December because of the Christmas season. While a different classifier may predict a low propensity to purchase the Santa hat because the user has not purchased such a hat in 12 months, the LSTM network can “remember” the context in which the Santa hat was last purchased and make a more accurate prediction.

FIG. 27 shows a block diagram for an LSTM algorithm. Like all RNNs, LS™ networks are formed from chains of cells, where a particular cell has a time step. Time binned feature data is analyzed by the LSTM in multiple input cycles, with features belonging to a time bin analyzed during a corresponding LSTM time step. Each cell in an LSTM network has an internal state, which stores information and is analogous to “long-term memory”. The internal state is propagated through the LSTM network. An LSTM cell outputs a hidden state, which is information from the internal state that is immediately relevant for making a prediction for the cell's corresponding time step. Information from the internal state that is not immediately relevant may become relevant during a future time step, and can be passed to the hidden state when it does become relevant. Thus, the hidden state is analogous to the LSTM network's “short-term memory”. Like the internal state, the hidden state is also propagated through the network.

In each LSTM cell, information is selectively committed to memory by adding and removing information from the internal state. Information is added and removed using structures called gates. An input gate controls which information from the time-binned feature data and previous cell's hidden state is allowed to contribute to the LSTM cell's internal state. In other words, the input gate controls which new information for the time step needs to be committed to long-term memory. A forget gate controls which information from the previous internal state is allowed to contribute to the cell's internal state. In other words, the forget gate controls which previous state information to “remember” and which previous state information to “forget”. An output gate controls which information from the cell's internal state is used to contribute to the cell's hidden state. In other words, the output gate determines which information is immediately relevant for making a prediction. An input modulator enables the LSTM network to learn more quickly.

FIGS. 28A-D show four implementations of LSTM-based classifiers used by the propensity predictor. Some of the classifiers analyze only time binned transaction features, while others use combinations of time binned transaction features, time binned browsing features, and non-time binned features.

In some of the implementations, the classifier stacks LSTM layers to create a deeper neural network. In this arrangement, each stacked layer processes a different portion of the classification task. Stacking LSTM layers allows each individual LSTM layers to require fewer neurons, increasing training speed.

Dense layers, or fully connected layers, are used in the classifier both to create intermediate features between classifier layers and to produce output propensity scores. Dense layers configure the network to make predictions using all of the parameters within each network cell. This makes the output purchase propensity a function of all of the feature inputs.

In the implementation of FIG. 28A, the classifier uses 12 monthly time bins for a yearlong analysis period, in order to predict a purchase propensity for a 13^{th} month result time bin. The monthly binned feature data is analyzed by a first LSTM layer over 12 time steps, or input cycles. For each cycle, 23 time-binned cross-category and category-specific features are analyzed by the first LSTM layer. The category-specific features include features collected from shopping cart data for the dependent category and five independent categories. In this implementation, the first LSTM layer outputs 12 hidden state vectors, one for each input cycle. The 12 vectors are intermediate inputs for a second LSTM layer, which outputs an additional vector of intermediate inputs to a dense layer. The dense layer analyzes these intermediate inputs to produce the purchase propensity score, using an activation function.

The inventors created several additional implementations of the LSTM classifier. In each of the additional implementations, layers with different sets of inputs were merged together. After each merge, a dense layer was used to create an intermediate layer, that was then analyzed by successive layers in the classifier. In the implementation of FIG. 28B, the classifier merged a 12 monthly time bin LSTM layer with a four weekly time bin LSTM layer, in order to predict a purchase propensity for a fifth week result time bin. In the implementation of FIG. 28C, non-time binned summary data was added as an additional layer to the second implementation's network, following the monthly monthly/weekly LSTM layer. In the implementation of FIG. 28D, added an additional LSTM layer including weekly binned site visit feature data to the third implementation's network.

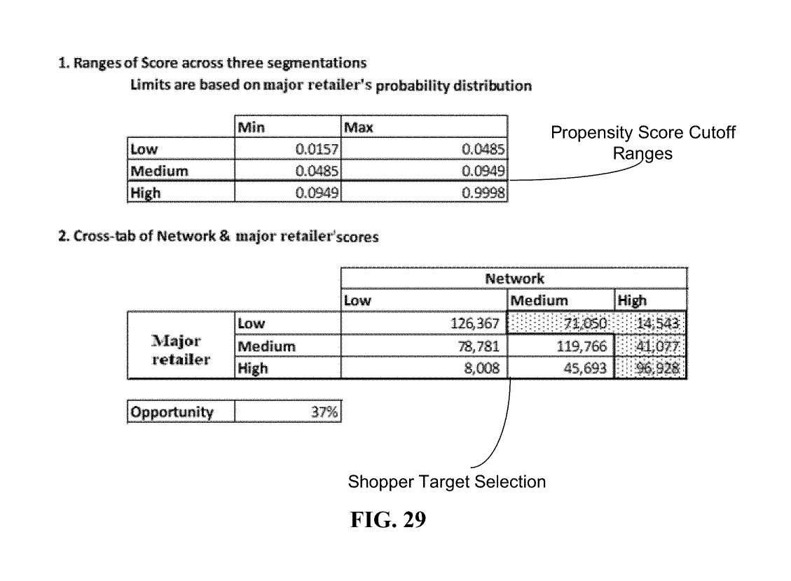

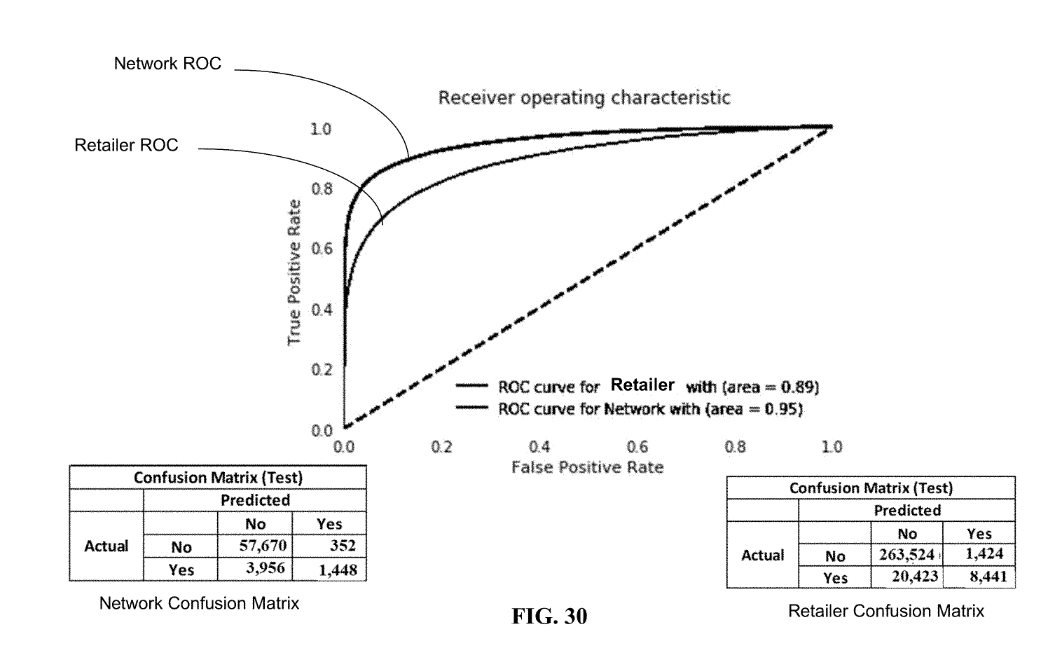

FIGS. 29 and 30 show classification results and evaluation statistics for the gradient tree boosting implementation of the classifier. Evaluators can use the same methods to test the performance of the LSTM implementation, as both classifiers output purchase propensity scores for dependent categories.

FIG. 29 shows a set of results used by a retailer to make a targeting decision based on user purchase propensity results from the gradient tree boosting machine learning model. Table 1 shows cutoff ranges for propensity scores for highly engaged users, with ranges for low propensity, medium propensity, and high propensity to purchase dresses. Table 2 shows a target selection table for a distribution of a major retailer customers with low, medium, and high propensities to purchase dresses both at the major retailer's stores and at other stores in the network, based on the cutoff ranges from the top table. For example, the 96,926 users in the bottom right-hand corner had purchase propensity scores for dresses between 0.0949 and 0.9998 for both the major retailer's stores and other network stores. But the 14,543 users in the top right hand corner had scores between 0.0949 and 0.9998 for network stores, but scores between 0.0157 and 0.0485 for the major retailer. The shaded cells show users that the major retailer is likely to target in order to drive those users to the major retailer's store to purchase dresses. The opportunity number shows that these users make up 37% of users that shop both at the major retailer's stores and other network stores.

FIG. 30 shows performance evaluation statistics for the machine learning model using gradient tree boosting. FIG. 30 shows confusion matrices for the major retailer and other network's customers and receiver operating characteristic (ROC) curves for the customers.

The confusion matrices in FIG. 30 show performance evaluation statistics for high-engagement users. In general, the performance of the classifier is evaluated based on the percentage of user purchasing decisions it correctly predicts. The model predicts a positive or negative user decision using a positivity threshold. For example, for a positivity threshold of 0.5, all users with scores above 0.5 are predicted to purchase a dress in the result time bin (a predicted positive), and all users with scores below 0.5 are predicted to not purchase a dress during the result time bin (a predicted negative). The confusion matrices show numbers of accurate and inaccurate predictions for the high-engagement users. The upper-left hand corner (No/No) shows the true negatives (TN), users correctly predicted to not purchase dresses during the result time bin. The upper-right corner (No/Yes) shows the false positives (FP)—users whom were predicted to purchase a dress but did not do so. The bottom-left corner (Yes/No) shows the false negatives (FN)—users who were predicted not to purchase dresses but actually did purchase dresses. The bottom-right corner (Yes/Yes) shows the true positives (TP), users whom were correctly predicted to purchase dresses during the result time bin. The accuracy of the model is measured using the following formula.

$$Accuracy = \frac{TP + TN}{TP + TN + FP + FN}$$

The accuracy expresses the proportion of the total number of users whose dress purchase behavior was accurately predicted, whether or not the users actually purchased dresses. For the major retailer's customers, the calculated accuracy of the model is 92.56% for high-engagement users. For network users, the calculated accuracy of the model is 93.21% for high-engagement users.

The receiver operating characteristic (ROC) graphically depicts the accuracy of the classifier's positive predictions as the positivity threshold is varied. For a positivity threshold, the receiver operating characteristic calculates a true positive rate (TPR) and a false positive rate (FPR), expressed using the following formulae:

$$TPR = \frac{TP}{TP + FN}$$

$$FPR = \frac{FP}{TN + FP}$$

The TPR is the proportion of users that was correctly predicted to purchase a dress by the classifier. The FPR is the proportion of users that was incorrectly predicted to purchase a dress by the model. The ROC is a graph of (FPR, TPR) points plotted for different positivity thresholds. A perfect receiver operating characteristic would be the vertical line FPR=0, signifying that, for any positivity threshold, the model predicts the decisions of 100% of the dress purchasers accurately and does not incorrectly predict any whom did not purchase a dress to have purchased one (100% true positives, no false positives). A diagonal line with slope TPR=FPR, on the other hand, signifies that, for any positivity threshold, true positives and false positives are equally likely. In other words, the classifier predicts no better than a person making random guesses. More accurate predictors thus have steeper slopes than the line TPR=FPR. The classifier's accuracy can also be expressed by measuring the area under the ROC curve (AUC). For the ROC with line TPR=FPR, the AUC is only 0.5, and for the vertical line ROC, the AUC is 1. Accurate classifiers thus have AUCs close to 1. The ROCs produced for both the major retailer and other network stores are curves that are above and to the left of the TPR=FPR line. The AUC for the major retailer ROC is 0.89 and the AUC for the network ROC is 0.95. The shapes of the ROCs and their AUCs signify that the classifier's positive predictions are accurate. In addition, the F1 Score can be used as a measure of the model's accuracy. The F1 score is the harmonic mean between the precision and the recall metrics, and may be used in cases where the training data has unbalanced classes. An F1 score of 1 is considered as the best prediction where both the precision and recall metrics are 1.

### Particular Implementations—Overall

We describe a system and various implementations of using machine learning and analytics to help brick and mortar stores compete with online shopping moguls. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

### Particular Implementations (1002)—Location Tracking Infrastructure

The technology disclosed relates to symbiotic reporting code and location tracking infrastructure for physical venues.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose an infrastructure system for generating visitor messages at a physical venue with at least five participating tenants. The technology disclosed not only applies to a single tenant location. This same approach may be applied to over multiple locations and sub-locations that have the same vendor operator. The infrastructure system includes a server registry of permission-based aggregated profiles with master identifiers (abbreviated IDs) for individual visitors. The server registry of the system includes (i) tenant-specific binned data individualized for the visitors that represents time-based events in time window bins organized into event categories, (ii) aggregated binned data individualized for the visitors that also represents time-based events in time-window bins organized into event categories, aggregated across at least the tenants, and (iii) pre-calculated intent propensities organized by the event categories, generated from the tenant-specific and aggregate binned data.

The system of this implementation also includes a location-based infrastructure of beacons. These beacons are deployable to the physical venue. The beacons generate distinctive messages. The system also includes a server beacon resolver that is able to determine visitor location based on receipt of beacon messages by mobile devices carried by the visitors. The system also includes symbiotic reporting code that is distributed to providers of apps that run on the mobile devices carried by the visitors that causes the mobile devices to collect the beacon messages. This symbiotic report code and the apps cause the mobile devices to report the beacon messages and a mobile device identifier to the server beacon resolver.

The system includes a location-based infrastructure of registered visitor Wi-Fi access points deployable to both the physical venue and a server Wi-Fi resolver. The server Wi-Fi resolver determines visitor location based on receipt of MAC address identifiers from the mobile devices carried by the visitors. The system further includes a distribution server that distributes profile and location data to the participating tenants, when the distribution server is coupled in communication with (i) the server registry of the permission-based aggregated profiles, (ii) the server beacon resolver, and (iii) the server Wi-Fi resolver.

Examples of aggregated binned data individualized for the visitors include time-based events in time-window bins organized into event categories, collected from non-tenant entities.

Examples of time-based invents include interactions of an individual visitor with items in physical space, virtual space or online, with particular item interactions organized into particular event categories.

An example of an event includes an event that involves locations in the physical venue at times that an individual visitor was on a journey through the physical venue.

Other examples of aggregated binned data individualized for the visitors include individual visitor opt-in permissions for both location tracking and messaging organized by data source.

In an implementation the beacons transmit unique messages tied to their locations using Bluetooth Low Energy (abbreviated BLE). Additionally, in an implementation the distinctive messages from the beacons are encrypted.

The server beacon resolver of the system, in an example, receives (i) reports from mobile devices of at least one received beacon message and (ii) an accompanying received signal strength indicator (abbreviated RSSI). The serer beacon resolver, in an example, uses one beacon message to approximate a location. The server beacon resolver, in another example, uses multiple beacon messages to refine the location, and then reports the approximate or refined location.

The symbiotic reporting code, as an example, collects and reports (e.g., information) when the code in a foreground mode or when the code is active in a background mode of running on the mobile device.

In an example, registration (for use of the registered visitor Wi-Fi access points) associates a visitor email address with MAC address identifiers from the mobile devices carried by a registered visitor.

The registered visitor Wi-Fi access points, in an example, report obfuscated MAC addresses and access point identifiers to the server Wi-Fi resolver. As another example, the registered visitor Wi-Fi access points are configurable to report connected MAC addresses and access point identifiers to the server Wi-Fi resolver. Further, as an example, the registered visitor Wi-Fi access points report signal direction of arrival data with the MAC address identifiers. Additionally, for example, the registered visitor Wi-Fi access points report received signal strength indicator data (abbreviated RSSI) with the MAC address identifiers.

As a further example, the distribution server enforces proprietary boundaries between tenants. This prevents second tenant-specific data from being reverse engineered by a first tenant from distributed aggregated data and first tenant-specific data.

The permission-based aggregated profiles with master identifiers, for example, include a visitor name and other personally identifiable information. As another example, the permission-based aggregated profiles with master identifiers include a visitor photograph and other personally identifiable information. Additionally, for example, he permission-based aggregated profiles with master identifiers do not include a visitor name or visitor photograph.

### Particular Implementations (1003)—Machine Learning Intent Propensities

The technology disclosed relates to machine learning-based systems and methods of determining user intent propensity from binned time series data.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of configuring an intent propensity predictor. The method includes transforming time series of event data using a processor to form a training set. This transforming of the time series of event data further includes (i) binning hyper-location information by user from physical browsing by the user at a venue having multiple sublocations in time-oriented product category bins, (ii) further binning online browsing and consequent conversion history information of a user in time-oriented category bins (the category bins are hierarchically arranged from at least dozens of main categories through hundreds or thousands of conversion-specific items, such as product stock keeping units (abbreviated SKUs) and (iii) further binning PoS terminal information by user in the time-oriented category bins.

In an implementation the method further includes training a classifier using (i) a combination of the binned online browsing and consequent conversion history, (ii) the PoS terminal information, and (iii) the hyper-location information (collectively referred to as binned data), to output category intent propensities on a per user basis. The method, in an implementation, includes persisting coefficients resulting from the training of the classifier.

A further implementation of the method includes combining binned purchase amount information with the category intent propensities. The method, for example, also includes training the classifier using the combination to output an expected product category purchase value on the per user basis.

In an implementation, the output of, for example, the category intent propensities, is generated in dependence upon account seasonal factors.

An example implementation of the method also includes training the classifier for a specific sublocation of the venue using sublocation-specific binned data individualized for the users.

In one implementation the method further aggregates the binned data individualized for the users across non-tenant binned browsing and consequent conversion history information of a user in time-oriented category bins. The technology disclosed not only applies to a single tenant at a single location. This same approach may be applied to over multiple locations and sub-locations that have the same vendor operator.

Examples of some of the events include interaction of the user with items in physical space, virtual space or online, with particular item interactions organized into particular event categories. Other examples of the events include locations in the physical venue at times that the user was on a journey through the venue.

In an implementation the method utilizes individual user opt-in permissions for location tracking and for messaging organized by data source.

In one implementation, a method is described that includes receiving at least first and second items that are real-world places, services or upcoming events. The method further includes retrieving from storage a plurality of characteristics of the first and second items, including at least the characteristics including how good each item is for an item category, particular subject/type, occasion, group of people, mood, and time of day. The method can further include scoring similarity of the first and second items based on similarity of the characteristics.

In another implementation, a method is described for configuring a purchase propensity predictor. The method comprises: (a) generating for individual users category-specific and cross-category tabulations by a time bin of PoS terminal shopping cart data for input time bins and for a result time bin following the input time bins; (b) calculating a recency score, a frequency score, a purchase interval score and a monetary score for the individual users from the tabulations by time bin; (c) clustering the individual users by their recency score, frequency score, purchase interval score and monetary score into engagement groups; (d) generating from the PoS terminal shopping cart data, for individual purchase categories, a category-specific affinity analysis between a dependent purchase category and a predetermined number of independent purchase categories that are calculated to most strongly lift sales in the dependent purchase category; and (e) in an engagement group for the dependent purchase category, training a classifier using feature data from the dependent purchase category and the independent purchase categories to predict respective purchase propensity scores for the individual users.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

Other implementations may include a non-transitory computer readable storage medium storing instructions executable by a processor to perform a method as described above. Yet another implementation may include a system including memory and one or more processors operable to execute instructions, stored in the memory, to perform a method as described above.

This method and other implementations of the technology disclosed can each optionally include one or more additional features described.

The method can further include repeating the evaluating and presenting actions two or more times as the data representing user choices is received.

In some implementations, the PoS terminal shopping cart data comprise online and offline purchase data, and online and offline browsing data.

In some implementations, a purchase propensity score for an individual user is a likelihood of the individual user purchasing an item from the dependent purchase category during the result time bin.

In some implementations, an individual purchase category includes a plurality of individual products.

In some implementations, generating a category-specific affinity analysis for an individual purchase category and an additional individual purchase category further includes: (a) determining a proportion of purchases that include a first purchase category, supp(A); (b) determining a proportion of purchases that include a second purchase category, supp(B); (c) determining a proportion of purchases that include both the first and second purchase categories, supp(AB); and (d) calculating the category-specific affinity analysis using a formula:

Lift=supp(AB)/(supp(A)×supp(B)).

In some implementations, the time bin of PoS terminal shopping cart data includes user transactions recorded during a time interval, wherein the time interval has a defined start point and a defined end point.

In some implementations, respective input time bins have label names that include an ordinal position that reflects a count of time periods from a result time bin back to the respective input time bins.

In some implementations, category-specific tabulations include total spending on items from a single category within a time bin and number of items from a single category purchased within a time bin.

In some implementations, cross-category tabulations include total spending on items across all categories within a time bin and number of items across all categories purchased within a time bin.

In some implementations, the classifier uses a gradient tree boosting algorithm. In some implementations, the feature data is analyzed by the classifier in a single input cycle for the tabulations in multiple time periods. In some implementations, the classifier uses a long short-term memory (LSTM) algorithm and the feature data is analyzed by the classifier in multiple input cycles for the tabulations in multiple time periods, with each input cycle analyzing feature data from one time bin, sequentially by ordinal position of time bin label. In some implementations, the feature data also includes data that is not time binned for characteristics of the individual users. In some implementations, training the classifier uses a binary cross-entropy loss function. In some implementations, evaluating results of a training by using the classifier on a test set of data having a ground truth, applying a threshold to the purchase propensity scores for respective test cases to produce binary values, and calculating a confusion matrix that uses the binary values and a ground truth to categorize respective test cases as false-negative, true-negative, false-positive and true-positive.

In some implementations, the recency score expresses a count of time bins from the result time bin back to a most recent time bin in which a purchase was made. In some implementations, the purchase interval score is an average time in days between purchases through a period of time. In some implementations, the frequency score expresses a user's total number of purchases in the tabulations by time bin. In some implementations, the monetary score expresses a total amount a user spent on purchases in the tabulations by time bin.

### Particular Implementations (1004)—Visitor to Venue

The technology disclosed relates to using machine learned visitor intent propensity to greet and guide a visitor at a physical venue.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to greeting upon arrival, we disclose a method of greeting a visitor at a venue. The method, for example, includes recognizing arrival of a mobile device carried by a visitor at a venue having participating tenants. The technology disclosed not only applies to a single tenant at a single location. This same approach may be applied to over multiple locations and sub-locations that have the same vendor operator.

The method also includes informing servers representing the participating tenants of arrival of the visitor. This “informing” is accompanied by a profile of the visitor, tenant-specific information and aggregate intent propensity information. The method further includes receiving and evaluating proposed messages from the servers representing the participating tenants for a predetermined limit on messages. According to the method, selected methods are forwarded, where the messages are selected by the evaluating to the mobile device carried by the visitor.

In an example implementation, the method includes recognizing the arrival of the mobile device carried by the visitor. This is based on beacon reporting from the mobile device carried by the visitor.

As an example of the beacon reporting, the beacon reporting is received from symbiotic reporting code running on an app on the mobile device. The app on the mobile device can be (i) a social media app, (ii) a navigation app, and/or (iii) a ride sharing app. The app can also be running in a foreground mode or an active background mode of the mobile device. As another example of the beacon reporting, the beacon reporting includes at least one encrypted message from a beacon having a registered location within the venue.

Further, as an example of the profile, the profile includes (i) a visitor name, (ii) a visitor photograph, (iii) other personally identifiable information and/or (iv) a unique identifier but not a visitor name or photograph.

In an implementation, the intent propensity information does not include a specific predetermined intent based on recent online activity of the visitor. Additionally, for example, the tenant-specific and aggregate intent propensity information is pre-calculated prior to the arrival and binned by category in the visitor's profile.

According to an implementation, the method includes evaluating the proposed messages for at least consistency with (between) the tenant-specific and aggregate intent propensity information.

Examples of evaluating the proposed messages, as performed by the method, are provided below. One example includes evaluating the proposed messages for consistency based on semantic analysis of the proposed messages against the tenant-specific and aggregate intent propensity information. Other example includes evaluating the proposed messages, for example, using a multi-layer convolutional neural network. Another example includes updating the evaluating of the proposed messages (as a location of the visitor within the venue) using a recurrent neural network. Another example includes updating the evaluating of the proposed messages (as a location of the visitor within the venue) using a convolutional neural network, a multi-layer convolutional neural network, and an attention mechanism.

In an implementation the method includes queuing unused messages among the received messages. As an example, the selected unused messages are forwarded to the visitor based on location updates obtained or that occurred during a journey of the visitor through the venue. For example, according to the method, the messages selected by the evaluating are forwarded to the mobile device within less than five minutes of the arrival.

Further, in an implementation, the method includes determining that the visitor has at least one identified intent upon arrival at the venue. This is done using recent online browsing activity. Additionally, the method includes, for example, informing the participating tenants of the identified intent and/or evaluating the proposed messages from the servers representing the participating tenants for at least consistency with the identified intent.

The method, in an implementation, includes prioritizing the proposed messages based at least in part to complement the identified intent. Additionally, the method includes delivering the prioritized messages not exceeding the message limit.

Further example of the method include (i) determining that the visitor has at least one identified intent upon arrival at the venue, where this can be done based on an entitlement being fulfilled at the venue, (ii) further informing the participating tenants of the identified intent, and (iii) further evaluating the proposed messages from the servers representing the participating tenants for at least consistency with the identified intent.

In one implementation related to a next best offer or obtaining a next best offer, we disclose a method of helping a visitor proceed in a journey through a facility having multiple tenants. The technology disclosed not only applies to a single tenant at a single location. This same approach may be applied to over multiple locations and sub-locations that have the same vendor operator. The method includes planning, upon arrival at the facility, a sequence of messages to lead the visitor on the journey through the facility. This sequence of messages is constructed based on (i) binned profile data for the visitor and, at least, (ii) a calculation of current intent indications for the visitor.

The method of this implementation further includes updating the plan based on hyper-location data obtained after the arrival. This reveals a course of an actual journey by the visitor through the facility. The method further includes periodically messaging a mobile device carried by the visitor with messages based on the updated plan.

In an implementation according to this method, a dwell time of the visitor at two or more tenants that is used in a recalculation, results in changed current intent indications. Further, the method includes causing presentation of an incentive to the visitor based on the recalculation.

In another implementation the method informs servers representing the tenants of arrival of the visitor. This informing is accompanied by the changed current intent indications. Also, in an example the method receives and evaluates proposed messages from the servers representing the tenants, and forwards messages selected by the evaluating to the mobile device carried by the visitor.

For example, the dwell time of the visitor at two or more tenants are used in a recalculation and results in changed current intent indications, such that the method informs servers representing the tenants of arrival of the visitor, accompanied by the changed current intent indications.

In an implementation the method receives and evaluates proposed messages from the servers representing the tenants and also forwards messages selected by the evaluating to the mobile device carried by the visitor.

### Particular Implementations (1005)—Gender and Age Context

The technology disclosed relates to providing gender and age context for user intent when browsing or searching.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. This method includes receiving a gender context query from a provider for a content request by an identified user, and also includes accessing an aggregated profile with an interest history organized by provider for the identified user. In an implementation includes determining an a priori most likely gender context based on the provider and the aggregated profile, as well as returning a gender context identifier responsive to the query, based on the determining.

An example of the aggregated profile for the identified user includes pre-calculated clusters of gender and age for distinct personalized historical interests of the identified user. The method, for example, determines the a priori most likely gender context as one of the distinct personalized historical interests.

Examples of the pre-calculated clusters include style preferences of the distinct personalized historical interests.

Another example of the aggregated profile for the identified user includes pre-calculated historical frequencies of gender and age interest, organized by provider for the identified user.

In an implementation the method accesses recent browsing history of the identified user, as well as combines a priori likelihood with recent browsing history to determine the most likely gender context.

Further, for example the method includes receiving an age context query with the gender context query. This makes it possible to use the aggregated profile for the identified user to determine and return the most likely age context.

An implementation of this method, for example includes (i) receiving an age context query with the gender context query, and/or (ii) using the aggregated profile for the identified user to determine and return the most likely age context as one of the distinct personalized historical interests.

According to another implementation the method (i) receives an age context query with the gender context query, and/or (ii) uses the aggregated profile for the identified user to determine and return the most likely age context.

In a further implementation the method (i) receives an age context query with the gender context query, and/or (ii) combines a priori likelihood with recent browsing history to determine and return the most likely age context.

### Particular Implementations (1006)—Ensemble

The technology disclosed relates to generating an individualized ensemble of complementary items in complementary item categories.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation, we disclose a method of enhancing a user browsing experience. The method includes detecting an indication of interest in an item for an identified user, as well as invoking an ensemble engine with the item of interest. The method, for example, also responsively receives, from the ensemble engine, an ensemble of item categories that complement the item of interest.

Further, the method retrieves an aggregate profile for the identified user, as well as determines preference of the user for a category among recommended categories in the ensemble of item categories, determines feature preferences of the identified user that apply to the recommended categories, and uses the determined category and feature preferences to select items to include in an ensemble of items. The method also includes causing display (to the identified user) of the ensemble of items selected using the determined category and feature preferences of the identified user.

In another implementation the method detects the interest in the item (i) during online browsing by the identified user, (ii) during physical browsing by the identified user at a physical location, and/or (iii) from a PoS terminal adjacent to the identified user.

In an example, the method determines (from the aggregate profile) a group interest pattern. The method can also select items from the group interest pattern to include in the ensemble of items selected.

In various implementations the method determines (i) a style preference among the feature preferences, (ii) a size preference among the feature preferences, and/or (iii) a color preference among the feature preferences.

In other various implementations the method causes display (to the user) on (i) a mobile device held by the user, (ii) a display adjacent to the user, and/or (iii) a display of a mobile device held by a person assisting the user.

### Particular Implementations (1007)—Modifying Purchase Behavior

The technology disclosed relates to systems and methods of individualized incentives to modify shopper behavior.

The technology disclosed can be practiced as a system or systems, a method or methods, non-transitory computer readable storage medium storing instructions executable by a processor to perform any of the methods, of the or article of manufacture. One or more features of an implementation can be combined with the base implementation. The system or systems may include memory and one or more processors operable to execute instructions, stored in the memory, to perform any of the methods.

Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

In one implementation related to buying online and returning at a store, we disclose method of handling returns for retailers with both online and physical presences. The method includes interacting with a user online responsive to a return request, as well as evaluating specific goods identified by the user to be returned and determining a first incentive value based on a cost of processing the return. The method also causes presentation (to the user) of an incentive offer that is less than or equal to the first value in exchange for returning the specific goods at a physical location instead of by shipping. The method further, upon accepting the incentive, pre-arranges receipt of return of the specific goods at the physical location. This can also include giving the user a token to present when visiting the physical location.

Examples of evaluating the specific goods include (i) taking into account the user's history of return to a physical location of goods purchased online and/or (ii) taking into account and a history of return patterns by the user.

In an implementation the method (i) evaluates binned profile data for the user, (ii) determines a second incentive value based on bringing the user to a physical location, and/or (iii) combines the first and second incentive values and presenting the user the incentive offer with a value less than or equal to the combined first and second incentive values, instead of an offer with a value less than or equal to the first incentive value.

In an example implementation the method directs the incentive to ensemble items available at the physical location. In another example implementation the method causes presentation of a list of physical locations to the user and receives a selection of the physical location for return. In a further example implementation the token to present is a scan code pattern.

In another implementation related to buying online and picking up at a store, we disclose method of handling fulfillment for retailers with both online and physical presences. This method interacts with a user online responsive to a purchase request, evaluates specific goods identified by the user to be purchased, and determines a first incentive value based on a cost of fulfilling the purchase request. Further, this method includes causing presentation (to the user) of an incentive offer that is less than or equal to the first value in exchange for picking up the specific goods at the physical location instead of receiving the specific goods by shipping. Additionally, this method, upon acceptance of the incentive, pre-arranges pick up of the specific goods at the physical location, including giving the user a token to present when visiting the physical location.

In an example implementation of this method, the method determines immediate availability of the specific goods ordered and accompanying the incentive offer with assertion of the immediate availability.

An example of evaluating specific goods, as performed by this method, includes evaluating specific goods identified by taking into account the user's history of pick up from a physical location of online purchases.

In an implementation the method includes (i) evaluating binned profile data for the user and determining a second incentive value based on bringing the user to a physical location, (ii) combining the first and second incentive values, and/or (iii) presenting the user the incentive offer with a value less than or equal to the combined first and second incentive values, instead of an offer with a value less than or equal to the first incentive value.

The method also includes, in an example implementation, (i) directing the incentive to ensemble items available at the physical location, and/or (ii) causing presentation of a list of physical locations (to the user) and receiving a selection of the physical location for return. In another implementation the token to present is a scan code pattern.

In one implementation related to underestimated shoppers, we disclose method of converting shoppers to in-retailer purchases. This method includes receiving an identified shopper from a retailer with an interest context directed to a product, as well as determining a product category that includes the product. In an implementation this method also determines (from an aggregated profile for the identified shopper) (i) an in-retailer purchase propensity and (ii) overall purchase propensity for the product category or for an ensemble of related product categories. The method further includes comparing the in-retailer purchase propensity and overall purchase propensity, as well as determining that the in-retailer purchase propensity underestimates the overall purchase propensity. This method also causes an alert (based on the determined underestimate) to the retailer that the identified purchaser is a conversion candidate for in-retailer purchases.

Examples of identified shoppers being received include the identified shopper being received from the retailer from (i) the retailer during online browsing by the shopper, (ii) the retailer during physical browsing by the shopper, and/or (iii) the retailer from a point-of-sale system during checkout by the shopper.

In an implementation the method determines the product category within a SKU hierarchy from a SKU.

In another implementation the method calculates and causes display of an incentive to convert the identified shopper to an in-retailer purchase in the product category or ensemble of product categories.

The method, for example also includes causing initiating of direct marketing (to the identified shopper) directed to the product category or ensemble of product categories.

In one implementation related to price elasticity, we disclose method of customizing an incentive for a visitor. This method includes receiving a specification of one or more goods under consideration by a visitor who has a purchase history, as well as determining a set of prior purchases of prior goods by the visitor in one or more categories correlated with the goods under consideration. This method further compares prices actually paid for the prior goods with standard prices for the prior goods, and also generates a discount-orientation rating for the visitor based on the comparing.

In an example implementation this method receives the specification of the goods under consideration, as product stock keeping units (abbreviated SKUs), as well as determines the categories correlated with the goods under consideration. This is done from a hierarchy arranged from dozens of main categories through hundreds or thousands of SKUs.

In another example implementation the method (i) generates a numerical discount-orientation rating, (ii) generates a categorical discount-orientation rating, (iii) adjusts an incentive presented to the visitor based on the discount-orientation rating, (iv) determines to provide a future upgrade incentive to the visitor based on a price insensitive discount-orientation rating, and/or (v) determines to provide an discount incentive to the visitor based on a price sensitive discount-orientation rating.

In one implementation related to a luxury buyer special service, we disclose method of rationing attention devoted to a visitor. This method includes receiving a signal from a mobile device allowing identification of a visitor upon arrival at a venue, as well as accessing an aggregated profile for the identified visitor, and determining an aggregated luxury purchase index for a particular retailer at the venue and a luxury purchase index aggregated across retailers. This message also includes messaging a server representing the particular retailer at the venue identifying the visitor as a luxury buyer based on one or both of the luxury purchase indexes.

In an example implementation this method involves multiple participating retailers being located at a venue further including. This further includes informing servers representing the participating retailers of arrival of the visitor at the venue, accompanied by a profile of the visitor and retailer-specific and aggregate intent propensity information from the aggregated profile. Additionally, this method incudes receiving and evaluating proposed messages from the servers representing the participating retailers, as well as forwarding messages selected by the evaluating to the mobile device carried by the visitor.

Examples of this method further includes evaluating the proposed messages for (i) at least likelihood of success based on the aggregate intent propensity information, and/or (ii) at least price offered for delivery of the proposed messages.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

What is claimed is:

1. A method of configuring a purchase propensity predictor, including:
generating for individual users category-specific and cross-category tabulations by a time bin of PoS terminal shopping cart data for input time bins and for a result time bin following the input time bins;
calculating a recency score, a frequency score, a purchase interval score and a monetary score for the individual users from the tabulations by time bin;
clustering the individual users by their recency score, frequency score, purchase interval score and monetary score into engagement groups;
generating from the PoS terminal shopping cart data, for individual purchase categories, a category-specific affinity analysis between a dependent purchase category and a predetermined number of independent purchase categories that are calculated to most strongly lift sales in the dependent purchase category; and
in an engagement group for the dependent purchase category, training a classifier using feature data from the dependent purchase category and the independent purchase categories to predict respective purchase propensity scores for the individual users.

2. The method of claim 1, wherein the PoS terminal shopping cart data comprise online and offline purchase data, and online and offline browsing data.

3. The method of claim 1, wherein a purchase propensity score for an individual user is a likelihood of the individual user purchasing an item from the dependent purchase category during the result time bin.

4. The method of claim 1, wherein an individual purchase category includes a plurality of individual products.

5. The method of claim 4, wherein generating a category-specific affinity analysis for an individual purchase category further includes:
for the individual purchase category and an additional individual purchase category:
determining a proportion of purchases that include a first purchase category, supp(A);
determining a proportion of purchases that include a second purchase category, supp(B);
determining a proportion of purchases that include both the first and second purchase categories, supp(AB); and
calculating the category-specific affinity analysis using a formula:
$$Lift = \frac{supp ( AB )}{supp ( A ) \times supp ( B )} .$$

6. The method of claim 1, wherein the time bin of PoS terminal shopping cart data includes user transactions recorded during a time interval, wherein the time interval has a defined start point and a defined end point.

7. The method of claim 6, wherein respective input time bins have label names that include an ordinal position that reflects a count of time periods from a result time bin back to the respective input time bins.

8. The method of claim 6, wherein category-specific tabulations include total spending on items from a single category within a time bin and number of items from a single category purchased within a time bin.

9. The method of claim 6, wherein cross-category tabulations include total spending on items across all categories within a time bin and number of items across all categories purchased within a time bin.

10. The method of claim 1, wherein the classifier uses a gradient tree boosting algorithm.

11. The method of claim 10, wherein the feature data is analyzed by the classifier in a single input cycle for the tabulations in multiple time periods.

12. The method of claim 11, wherein the classifier uses a long short-term memory (LSTM) algorithm.

13. The method of claim 12, wherein the feature data is analyzed by the classifier in multiple input cycles for the tabulations in multiple time periods, with each input cycle analyzing feature data from one time bin, sequentially by ordinal position of time bin label.

14. The method of claim 1, wherein the recency score expresses a count of time bins from the result time bin back to a most recent time bin in which a purchase was made.

15. The method of claim 1, wherein the purchase interval score is an average time in days between purchases through a period of time.

16. The method of claim 1, wherein the frequency score expresses a user's total number of purchases in the tabulations by time bin.

17. The method of claim 1, wherein the monetary score expresses a total amount a user spent on purchases in the tabulations by time bin.

18. The method of claim 1, wherein the feature data also includes data that is not time binned for characteristics of the individual users.

19. The method of claim 1, wherein training the classifier uses a binary cross-entropy loss function.

20. The method of claim 1, further including evaluating results of a training by using the classifier on a test set of data having a ground truth, applying a threshold to the purchase propensity scores for respective test cases to produce binary values, and calculating a confusion matrix that uses the binary values and a ground truth to categorize respective test cases as false-negative, true-negative, false-positive and true-positive.

21. A computer system for configuring a purchase propensity predictor comprising:
a processor; and
a memory coupled to the processor, the memory storing a program that, when executed by the processor, causes the processor to:
generate for individual users category-specific and cross-category tabulations by a time bin of PoS terminal shopping cart data for input time bins and for a result time bin following the input time bins;
calculate a recency score, a frequency score, a purchase interval score and a monetary score for the individual users from the tabulations by time bin;
cluster the individual users by their recency score, frequency score, purchase interval score and monetary score into engagement groups;
generate from the PoS terminal shopping cart data, for individual purchase categories, a category-specific affinity analysis between a dependent purchase category and a predetermined number of independent purchase categories that are calculated to most strongly lift sales in the dependent purchase category; and
in an engagement group for the dependent purchase category, train a classifier using feature data from the dependent purchase category and the independent purchase categories to predict respective purchase propensity scores for the individual users.

22. A non-transitory computer-readable medium storing instructions for configuring a purchase propensity predictor that, when executed by a processor, cause the processor to:
generate for individual users category-specific and cross-category tabulations by a time bin of PoS terminal shopping cart data for input time bins and for a result time bin following the input time bins;
calculate a recency score, a frequency score, a purchase interval score and a monetary score for the individual users from the tabulations by time bin;
cluster the individual users by their recency score, frequency score, purchase interval score and monetary score into engagement groups;
generate from the PoS terminal shopping cart data, for individual purchase categories, a category-specific affinity analysis between a dependent purchase category and a predetermined number of independent purchase categories that are calculated to most strongly lift sales in the dependent purchase category; and
in an engagement group for the dependent purchase category, train a classifier using feature data from the dependent purchase category and the independent purchase categories to predict respective purchase propensity scores for the individual users.
